(19) United States
(12) Patent Application Publication
(10) Pub. No.: US 2002/0026478 A1
(43) Pub. Date: Feb. 28, 2002

(54) Method and apparatus for forming linked multi-user groups of shared software applications

(76) Inventors: Edward B. Rodgers, Boston, MA (US); Hugues P. Steinier, Boston, MA (US); Thomas R. Leonard, Somerville, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/805,957

(22) Filed: Mar. 14, 2001

Related U.S. Application Data
(60) Provisional application No. 60/189,130, filed on Mar. 14, 2000.

(51) Int. Cl. G06F 15/16; G06F 15/177; G09G 5/00

(52) U.S. Cl. 709/205; 709/221; 345/753

(57) ABSTRACT

A method and apparatus for facilitating formation and maintenance of multi-user linked groups. In one aspect, a shared software application is automatically launched on two linked computers in response to formation of the linked multi-user group. In another embodiment, a linked multi-user group is initiated by a user submitting a request to form the group to another user. In a further embodiment, additional users can be dynamically added to an established linked multi-user group. In another embodiment, the list of participants in a linked multi-user group is distributed among all of the users in the group. In another embodiment, a multi-user linking interface provides a common interface for at least two linked applications.

### RELATED APPLICATIONS

The present application claims the benefit, under 35 U.S.C. §119(e), of U.S. Provisional Application Ser. No. 60/189,130, filed Mar. 14, 2000, and titled “Method and System for Decentralized Interconnection of Multiple Application Program Users,” which is hereby incorporated by reference.

### FIELD OF THE INVENTION

The present invention generally relates to linked multi-user groups of shared software applications.

### BACKGROUND

Various types of networks have been used to link multiple computer users, such as local area networks (servicing closed groups of users sharing a limited geographic work space, such as an office building); wide area networks (servicing a limited but more generally distributed group of users, possibly extending over a disparate work space or a virtual work space); and extended open networks such as the Internet.

Networks have been used to connect computer users over long distances. Users can communicate over telephone, Internet, and wireless communication networks using a variety of applications suitable for transferring information, computer data and messages between users. Examples of network communications include electronic mail (email), instant messaging, file and data exchange (such as by file transfer protocol (FTP) and gopher services), database applications, interactive gaming applications, etc.

The evolution of multi-user computer networks has generally followed two main models:

(1) Centralized, server-based systems, wherein the users communicate through a server which is used to route, store, and/or translate (or otherwise process) all message and data traffic between users; and

(2) Decentralized networks of users, sometimes referred to as peer-to-peer networks. These networks generally do not require servers to control communication between users, but may include servers as part of the network. The term peer-to-peer is in reference to the absence of an intrinsic hierarchical relationship between members of the network. In the peer-to-peer model, substantially all of the members of a network support roughly equivalent capabilities and in some instances directly interact to the extent supported by their available hardware and installed software, without the aid of a server. While peer-to-peer systems may employ routers or communication services servers, the exchanged data packets are essentially unaltered along the communication paths. By contrast, client-server architectures normally involve some degree of processing of exchanged data.

In the centralized server-based model, the utility and standardization afforded by the server is offset by reliability concerns in the event of a loss of the server, the cost of the server itself, and in some cases, a reduced efficiency due to bottlenecking and architectural constraints. On the other hand, compatibility concerns can be more significant in peer-to-peer networks than in centralized server based networks, and routing issues can arise in the absence of a centralized server.

One particularly robust type of multi-user communication is referred to herein as a linked multi-user group in which one or more software applications are shared. An example of this type of multi-user communication is found in the on-line computer game industry, wherein multiple users can be connected in a linked multi-user group to share a software application implementing a particular game, thereby enabling the users to interact in a collaborative, essentially real-time fashion to play the game. For example, two users can participate in a linked multi-user group to share a software application that implements a game of checkers or chess. To do so, each of the users has a software application that implements the game and is launched on the user's computer. The two computers communicate so that their respective software applications share information to enable the two users to play the game in an interactive real-time manner. Once a linked multi-user group is established, real-time sharing of the software applications between the linked users may take place, allowing the users to interactively process data sets. The term real-time refers generally to the prompt delivery and exchange of information, where the information exchange latency is small enough to allow efficient and convenient use by users in an interactive session. That is, the exchange of information is not unduly delayed as to make an interactive multi-user session impractical.

While linked multi-user groups such as those described above provide a particularly robust form of communication between the users in a linked multi-user group, the conventional techniques used to initiate formation of such groups, to maintain such groups, and to enable communication between the multi-user applications can often be quite cumbersome, awkward and inconvenient for the users. In addition, the ability for a software application to participate in a linked multi-user group typically requires that the software application be specifically written to have that capability, which is true of only a very small percentage of software applications on the market, so that the vast majority of software applications cannot be used in such a linked multi-user group.

### SUMMARY OF THE INVENTION

One illustrative embodiment of the invention is directed to a method for automatically launching a software application on a first computer, the first computer being coupled to a second computer. The method comprises acts of: (A) receiving a link request at the first computer from the second computer, the link request identifying the software application, the link request further identifying a second user on the second computer and requesting that a first user on the first computer link with the second user to form a linked multi-user group that shares the software application; and (B) responsive to the first user accepting the link request, automatically launching the software application on the first computer. Another illustrative embodiment is directed to a computer readable medium encoded with a program that, when executed, performs this method.

Another illustrative embodiment is directed to a first computer for use in a computer system that includes the first computer and a second computer coupled to the first computer. The first computer comprises at least one controller to receive a link request at the first computer from the second computer, the link request identifying a software application, the link request further identifying a second user on the second computer and requesting that a first user on the first computer link with the second user to form a linked multi-user group that shares the software application, wherein the at least one controller is responsive to the first user accepting the link request to automatically launch the software application on the first computer; and at least one storage device to store the software application.

Yet another illustrative embodiment is directed to a method for launching a software application on a first computer, the first computer being coupled to a second computer. The method comprises acts of: (A) receiving a link request at the first computer from the second computer, wherein the link request identifies a second user on the second computer, provides an icon identifying the software application and requests that a first user on the first computer link with the second user to form a linked multi-user group that shares the software application; and (B) selecting the icon to automatically launch the software application on the first computer. Another illustrative embodiment is directed to a computer readable medium encoded with a program that, when executed, performs this method.

One exemplary embodiment provides a computer readable medium encoded with a computer program that, when executed on at least one computer, performs a method for launching a software application on a first computer, the first computer being coupled to a second computer, the method comprising acts of: (A) receiving a link request at the first computer from the second computer, wherein the link request identifies a second user on the second computer, provides an icon identifying the software application and requests that a first user on the first computer link with the second user to form a linked multi-user group that shares the software application; and (B) selecting the icon to automatically launch the software application on the first computer.

In another illustrative embodiment, a first computer for use in a computer system that includes the first computer and a second computer coupled to the first computer, the first computer comprising: at least one controller to receive a link request at the first computer from the second computer, the link request providing an icon identifying a software application, the link request further identifying a second user on the second computer and requesting that a first user on the first computer link with the second user to form a linked multi-user group that shares the software application, wherein the at least one controller is responsive to the first user selecting the icon to automatically launch the software application on the first computer; and at least one storage device to store the software application.

Another exemplary embodiment is directed to a method for facilitating launching of a software application on a first computer, the first computer being coupled to a second computer, the method comprising an act of: sending a link request from the second computer to the first computer, wherein the link request identifies a second user on the second computer and requests that a first user on the first computer link with the second user to form a linked multi-user group that shares the software application, and wherein the link request includes a launch icon that, when selected by the first user, automatically launches the software application on the first computer.

In one illustrative embodiment, a computer readable medium is encoded with a computer program that, when executed on at least one computer, performs a method for facilitating launching of a software application on a first computer, the first computer being coupled to a second computer, the method comprising an act of: sending a link request from the second computer to the first computer, wherein the link request identifies a second user on the second computer and requests that a first user on the first computer link with the second user to form a linked multi-user group that shares the software application, and wherein the link request includes a launch icon that, when selected by the first user, automatically launches the software application on the first computer.

An exemplary embodiment is directed to a second computer for use in a computer system that includes a first computer and the second computer coupled to the first computer, the second computer comprising: at least one controller to send a link request from the second computer to the first computer, wherein the link request identifies a second user on the second computer and requests that a first user on the first computer link with the second user to form a linked multi-user group that shares a software application, and wherein the link request includes a launch icon that, when selected by the first user, automatically launches the software application on the first computer; and at least one storage device to store the software application.

In another illustrative embodiment, a method is provided for initiating formation of a linked multi-user group between a first user on a first computer and a second user on a second computer coupled to the first computer, the method comprising an act of transmitting from the first computer to the second computer a link request to form the linked multi-user group so that the first and second users can share at least one software application.

An illustrative embodiment is directed to a computer readable medium encoded with a computer program that, when executed on at least one computer, performs a method for initiating formation of a linked multi-user group between a first user on a first computer and a second user on a second computer coupled to the first computer, the method comprising an act of transmitting from the first computer to the second computer a link request to form the linked multi-user group so that the first and second users can share at least one software application.

A further exemplary embodiment is directed to a first computer for use in a computer system that includes the first computer and a second computer coupled to the first computer, the first computer comprising at least one controller to transmit from the first computer to the second computer a link request to form a linked multi-user group between a first user on the first computer and a second user on the second computer so that the first and second users can share at least one software application; and at least one storage device to store the at least one software application.

One other illustrative embodiment is directed to a method for completing formation of a linked multi-user group between a first user on a first computer and a second user on a second computer coupled to the first computer, the method comprising acts of (A) receiving, at the second computer, a link request transmitted from the first user requesting formation of a linked multi-user group between the first and second users so that the first and second users can share at least one software application; and (B) accepting the link request at the second computer.

Another exemplary embodiment is directed to a computer readable medium encoded with a computer program that, when executed on at least one computer, performs a method for completing formation of a linked multi-user group between a first user on a first computer and a second user on a second computer coupled to the first computer, the method comprising acts of (A) receiving, at the second computer, a link request transmitted from the first user requesting formation of a linked multi-user group between the first and second users so that the first and second users can share at least one software application; and (B) accepting the link request at the second computer.

In yet another exemplary embodiment, a second computer is provided for use in a computer system that includes the second computer and a first computer coupled to the second computer, the second computer comprising at least one controller to receive and accept, at the second computer, a link request transmitted from a first user on the first computer requesting formation of a linked multi-user group between the first user and a second user on the second computer so that the first and second users can share at least one software application; and at least one storage device to store the at least one software application.

An illustrative embodiment is directed to a method of adding an additional user to a linked multi-user group that includes at least first and second users that share at least one software application, the method comprising an act of dynamically adding a third user to the linked multi-user group while maintaining the at least first and second users in continuous linked multi-user communication.

Another exemplary embodiment gives a computer readable medium encoded with a computer program that, when executed on at least one computer, performs a method for adding an additional user to a linked multi-user group that includes at least first and second users that share at least one software application, the method comprising an act of dynamically adding a third user to the linked multi-user group while maintaining the at least first and second users in continuous linked multi-user communication.

One other embodiment, given for illustrative purposes, is directed to a first computer for use in a computer system that includes the first computer and a second computer coupled to the first computer, the first computer comprising at least one controller to dynamically add a third user to a linked multi-user group, previously formed between a first user on the first computer and a second user on the second computer so that the first and second users can share at least one software application, while maintaining the at least first and second users in continuous linked multi-user communication; and at least one storage device to store the at least one software application.

Another exemplary embodiment is directed to a method for enabling a first software application on a first computer to be shared in a linked multi-user group with at least one other compatible software application on a second computer coupled to the first computer, wherein the first software application has a plug-in port to interface with software add-ons and has no capability coded therein for enabling its use in a linked multi-user group, the method comprising an act of providing a software add-on that is compatible with the plug-in port and that enables the first software application to be shared in a linked multi-user group with at least one other compatible software application on the second computer.

A further example is given by an embodiment directed to a computer readable medium encoded with a computer program that, when executed on at least one computer, performs a method for enabling a first software application on a first computer to be shared in a linked multi-user group with at least one other compatible software application on a second computer coupled to the first computer, wherein the first software application has a plug-in port to interface with software add-ons and has no capability coded therein for enabling its use in a linked multi-user group, the computer program including a software add-on that is compatible with the plug-in port, the method comprising an act of interfacing the first software application with the at least one other compatible software application on the second computer to enable the first software application to be shared in a linked multi-user group with the at least one other compatible software application.

Yet another exemplary embodiment is directed to a method of managing membership of a linked multi-user group of users that share at least one software application, the linked multi-user group including at least first and second users, the method comprising an act of authorizing at least the first and second users to each add additional users to the linked multi-user group.

In another embodiment, given as an example, a method is provided of managing membership of a linked multi-user group of users that share at least one software application, the linked multi-user group including a plurality of linked users, the method comprising an act of preventing any of the plurality of linked users from removing another of the plurality of linked users from the multi-user group.

Another illustrative embodiment is directed to a method for facilitating creation of a linked multi-user group of users that share software applications on a first computer with compatible software applications on a second computer, the method comprising acts of providing a multi-user linking interface on the first computer, the multi-user linking interface providing a common interface to at least two software applications on the first computer and being compatible with an interface on the second computer to enable the multi-user linking interface on the first computer to be used in establishing a linked multi-user group for the at least two software applications with compatible software applications on the second computer.

Another illustrative embodiment is directed to a computer readable medium encoded with a computer program that, when executed on at least one computer, performs a method for facilitating creation of a linked multi-user group of users that share software applications on a first computer with compatible software applications on a second computer, the method comprising an act of providing a multi-user linking interface on the first computer, the multi-user linking interface providing a common interface to at least two software applications on the first computer and being compatible with an interface on the second computer to enable the multi-user linking interface on the first computer to be used in establishing a linked multi-user group for the at least two software applications with compatible software applications on the second computer.

Yet another illustrative embodiment is directed to a first computer for use in a computer system that includes the first computer and a second computer coupled to the first computer, the first computer comprising at least one controller to provide a multi-user linking interface on the first computer, the multi-user linking interface providing a common interface to at least two software applications on the first computer and being compatible with an interface on the second computer to enable the multi-user linking interface on the first computer to be used in establishing a linked multi-user group for the at least two software applications with compatible software applications on the second computer; and at least one storage device to store the at least two software applications.

In another exemplary embodiment, a method is provided for assisting a user in entering information into a computerized document via a software application executing on the user's computer, the method comprising acts of creating a linked multi-user group between the user and a service representative so that the software application executing on the user's computer can be shared with a compatible software application executing on a computer used by the service representative; and transmitting a copy of the computerized document from the user's computer to the computer used by the service representative so that the service representative and the user can enter information in the computerized document simultaneously.

In one illustrative embodiment, a computer readable medium is encoded with a computer program that, when executed on at least one computer, performs a method for assisting a user in entering information into a computerized document via a software application executing on the user's computer, the method comprising acts of creating a linked multi-user group between the user and a service representative so that the software application executing on the user's computer can be shared with a compatible software application executing on a computer used by the service representative; and transmitting a copy of the computerized document from the user's computer to the computer used by the service representative so that the service representative and the user can enter information in the computerized document simultaneously.

Another exemplary embodiment is directed to a first computer for use by a user in a computer system that further includes a second computer used by a service representative, the first computer comprising at least one controller to create a linked multi-user group between the user and the service representative so that a software application executing on the user's computer can be shared with a compatible software application executing on the second computer used by the service representative, the at least one controller to further transmit a copy of a computerized document from the first computer to the second computer so that the service representative and the user can enter information in the computerized document simultaneously; and at least one storage device to store the software application.

Another illustrative embodiment is directed to a method for enabling shared access to a web page between a first user on a first computer and a second user on a second computer, the method comprising acts of: (A) creating a linked multi-user group between the first and second users to enable a first web browser executing on the first computer to be shared with a compatible second web browser executing on the second computer; and (B) transmitting a copy of at least a portion of the web page from the first web browser to the second web browser.

Yet another exemplary embodiment is directed to a computer readable medium encoded with a computer program that, when executed on at least one computer, performs a method for enabling shared access to a web page between a first user on a first computer and a second user on a second computer, the method comprising acts of (A) creating a linked multi-user group between the first and second users to enable a first web browser executing on the first computer to be shared with a compatible second web browser executing on the second computer; and (B) transmitting a copy of at least a portion of the web page from the first web browser to the second web browser.

Another illustrative embodiment is directed to a first computer for use by a user in a computer system that the first computer and a second computer coupled to the first computer, the first computer comprising at least one controller to create a linked multi-user group, between a first user on the first computer and a second user on the second computer, that enables a first web browser executing on the first computer to be shared with a compatible second web browser executing on the second computer, the at least one controller to further transmit a copy of at least a portion of a web page from the first web browser to the second web browser to enable the first and second users to share the at least a portion of the web page; and at least one storage device to store the first web browser.

### BRIEF DESCRIPTION OF THE DRAWINGS

FIG. 1 is a block diagram of a computer system wherein two computers have linking applications to facilitate linked multi-user group communication in accordance with one illustrative embodiment of the present invention;

FIG. 2 is a flow chart illustrating routines for executing on first and second computers for forming a linked multi-user group in accordance with one illustrative embodiment of the present invention;

FIG. 3 is a block diagram of a computer system wherein two users are in the process of establishing a linked multi-user group in accordance with one illustrative embodiment of the present invention;

FIG. 4 is a schematic representation of information provided in a request for establishing a linked multi-user group in accordance with one embodiment of the present invention;

FIG. 5 is a schematic illustration of a linker plug-in and linker application to enable a client application to be shared in a linked multi-user group in accordance with one illustrative embodiment of the present invention;

FIG. 6 is a block diagram of a computer system wherein two web browsers can be shared in a linked multi-user group in accordance with one embodiment of the present invention;

FIG. 7 is a conceptual illustration of the flow of data between the web browsers and a web server in the embodiment of the invention shown in FIG. 6, wherein updates to a web page result in the entire web page being transmitted between the shared web browsers;

FIG. 8 is a conceptual illustration of the data flow of an updated web page on a system such as that shown in FIG. 6, but according to an alternate embodiment of the invention wherein only incremental updates are transmitted between the shared web browsers;

FIG. 9 is a conceptual illustration of a hub and spoke topology for enabling a common multi-user interface to be employed for multiple client applications; and

FIG. 10 is a conceptual illustration demonstrating the formation of a second communication network in addition to a linked multi-user group in accordance with one illustrative embodiment of the present invention.

### DETAILED DESCRIPTION

Several embodiments of the present invention are directed to methods and apparatuses for facilitating the formation and maintenance of linked multi-user groups that share one or more software applications. As used herein, the phrase linked multi-user group refers to a group of users that, via at least one set of compatible software applications, shares a synchronized, end-user distributed data set. The data set can be of any type (e.g., a database or an object store), as the present invention is not limited to use with applications that share any particular type of data set. As indicated above, the data set is distributed, meaning that at least some pieces of the data set will be simultaneously updatable and stored in at least two different end-user computers by at least two different users in the multi-user group. Finally, the data set is synchronized, meaning that when an update is made by one of the users in the multi-user group to its associated copy of the distributed data set, that update is automatically (i.e., without requiring any action on behalf of the updating user other than simply updating its associated copy of the data set) transmitted to the other distributed copies of the data set that are associated with the other users in the group.

As should be appreciated from the foregoing, linked multi-user groups are distinguishable from other types of computer applications wherein multiple users can, to a lesser extent, share a software application. An example of another such application is an on-line auction service, wherein multiple users can participate in an auction over the Internet. Such systems are centralized and server based, such that the data set used therein is not distributed. In this respect, the multiple users using such a system do not update local copies of a distributed data set, but rather, simply submit commands to one or more of the centralized servers which each updates the single copy of the data set controlled by the central server. Thus, the data set in such a system can only be updated by a central server, and, therefore, is not distributed.

As mentioned above, one example of conventional linked multi-user groups is found in the game industry, wherein multiple users can form a linked multi-user group to share a software application that enables the users to interactively play a game together. Typically, the formation of such a linked multi-user group requires that the users initially communicate with each other through some means other than the application that they intend to link together to decide which application (e.g., which game) they intend to launch. Thereafter, one of the users creates a so-called “lobby” and makes it publicly available on a central server (e.g., a computer used by the user creating the lobby). Once the lobby is made publicly available, other users can request access to the lobby, with the creator of the lobby having control over who is granted access to enter into the lobby. Once all of the multiple users that want to be linked together have entered the lobby, each of the users then launches, on their respective computer, the application to be shared, and the linked multi-user group is then formed with the launched application being shared by all of the users in the group.

Applicants have discovered that there are a number of ways that improvements can be made to facilitate the formation and maintenance of linked multi-user groups. For example, in the conventional system discussed above, all of the users in the group must be present in the lobby when the application is launched in order to participate in the multi-user group. Therefore, if a new user desires to join a linked multi-user group after its formation, the existing linked multi-user group would need to be shut down, a new lobby would need to be created, all of the users would then need to enter the new lobby, and the software application would then need to be re-launched with the newly constituted multi-user group. Applicants have appreciated that this is cumbersome. Thus, one embodiment of the present invention is directed to a system for enabling additional users to be dynamically added to an established linked multi-user group.

A somewhat related problem results from the fact that conventional linked multi-user groups are application specific, such that a linked multi-user group is formed only to share a single software application. For example, if two users formed a linked multi-user group to allow them to play a first game (e.g., chess), and then decided that they would like to switch to another game (e.g., checkers), the users are forced to shut down the linked multi-user group established to play the first game, and then go through the formation process again to form a new linked multi-user group to share the second game. Applicants have appreciated that this is cumbersome, so that one embodiment of the present invention is directed to a system for enabling multiple users to form a linked multi-user group with a single interface that enables the group to share and move between any of multiple software applications without disbanding and recreating the group.

Applicants have also appreciated that it may be desirable in some circumstances to enable the formation and maintenance of a linked multi-user group to be controlled more democratically by all of the users in the group, as opposed to the manner in which this is done in the centralized server-based systems known today, wherein a single user has complete control over what users can be added to a multi-user group, and also has the authority to remove any user from the group. Thus, in accordance with another embodiment of the present invention, a method and apparatus is provided wherein at least two users in a multi-user group have the authority to add other users to the group. While this can be implemented in various ways, in one embodiment of the present invention every user in a multi-user group has the authority to add other users. In addition, in accordance with another embodiment of the present invention, no user in a multi-user group has the authority to remove another user against his/her will. Thus, while each user has the authority to remove themselves from an established linked multi-user group, no user can be removed involuntarily.

In accordance with another illustrative embodiment of the invention, the list of users in a linked multi-user group is distributed among the users in the group, as opposed to being consolidated at a centralized server (e.g., such as a server supporting the lobby in the conventional systems). This can be advantageous in that in the conventional systems, if a problem is experienced with the centralized server, the entire linked multi-user group can be lost. Conversely, in accordance with one illustrative embodiment of the present invention, the system is more fault tolerant, as problems with the computer associated with any single user in a linked multi-user group will not result in a disbanding of the group, as information relating to the identity of the users in the group is distributed throughout the group.

In accordance with another illustrative embodiment of the present invention, the capability to be shared in a linked multi-user group can be added to software applications that have no such capability coded therein. In this respect, as discussed above, using conventional technology, linked multi-user groups only can be formed to share software applications that are specifically coded for use in this manner (e.g., such as those in the game industry). Applicants have appreciated that it may be desirable to provide the capability for linking in a multi-user group to any of a wide variety of software applications that have no capability coded therein for enabling such shared use. Using this aspect of the present invention, any of numerous software applications (e.g., web browsers, word processing applications, design capture systems, etc.) can be provided with the capability of being shared in a linked multi-user group to enable data sets associated therewith to be shared in a collaborative way by multiple users. This aspect of the present invention can be implemented in any of numerous ways, and is not limited to any particular implementation. For example, this aspect of the present invention can be implemented as a software add-on that can be attached via a plug-in port that the software application may make available to interface with various types of software add-ons.

As mentioned above, the type of software applications to which linked multi-user grouping capability can be provided in accordance with one embodiment of the invention is not limited in any respect. Examples of software applications that can be multi-user enabled include editing, word processing, spreadsheet, Internet or World Wide Web (Web) browser applications, graphics, communications, scientific calculations, and multimedia software applications. Software applications normally have data files associated with them, with the files residing on a storage medium such as a computer hard disk or removable storage medium, and with the files containing data that can be processed in a useful manner by the associated software application. Examples of software application data files which can be multi-user enabled according to the embodiments of the present invention described herein include text files, spreadsheet files, database files, graphics files in any of many common formats (e.g., TIFF, JPEG, BMP, and GIF) and HTML files for use with Internet Web browsers. In addition, future implementations of Worldwide Web browsers, or those now appearing for wireless devices using the wireless markup language (WML) may be also adapted for use with the present invention. Of course, the present invention is not limited to use with the above-disclosed software application types or the data files associated therewith, as software applications and associated computer data files of any kind may be used with the embodiments of the present invention discussed herein.

Another embodiment of the present invention is directed to a method and apparatus for facilitating formation of a linked multi-user group. As discussed above, in the conventional systems, users must communicate through some means other than the application which they intend to link together to reach a decision that they wish to create a linked multi-user group. Applicants have appreciated that it would be more convenient in some circumstances for users to be able to communicate more directly to establish a linked multi-user group for sharing an application. Thus, one embodiment of the present invention is directed to a method and apparatus whereby one user can transmit a linking request to another user, requesting that the other user join the requesting user in forming a linked multi-user group. This is distinguishable from the conventional way in which linked multi-user groups are formed, wherein a lobby is created, and then users must come to the lobby requesting to be added to the multi-user group. That is, in the conventional lobby systems, the public server does not send out requests to users to join the multi-user group.

In one embodiment of the present invention, a linked multi-user group can be automatically formed by a user that receives a linking request simply accepting the request. In this respect, reference to the linked multi-user group being formed automatically refers to the linked multi-user group being formed in response to a user accepting a linking request, without requiring the accepting or requesting users to take any further action. Thus, this is believed to provide significant advantages over conventional systems, in that it is significantly easier for users to form a linked multi-user group in accordance with this embodiment of the invention.

In yet a further embodiment of the present invention, formation of a linked multi-user group is made even more convenient still by the link request from a user to form a linked multi-user group identifying not only the requesting user, but also the particular software application that the requesting user wishes to share in the linked multi-user group. In this respect, the link request can include an icon that identifies the application to be shared if the link request is accepted. In accordance with one embodiment of the present invention, acceptance of the link request and/or selection by the receiving user of the application icon results in the application to be shared in the multi-user group being automatically launched on the computer of the accepting user. In this respect, reference to the application being automatically launched is meant to indicate that the accepting user need take no additional action other than the action required to accept the linked request and/or select the application icon. It should be appreciated that this automatic launching significantly facilitates the formation of the linked multi-user group, in that the accepting user need not navigate through his computer system to locate the application and launch it manually.

In accordance with a related and optional embodiment of the present invention, the process of automatically launching the software application to be shared can also include a process for automatically performing a check to ensure that the requesting and accepting computers have compatible versions of the software application installed thereon. As used herein, the reference to the software applications being compatible refers to the applications being capable of being shared in a linked multi-user group, and the reference to the checking being performed automatically refers to the requesting and accepting users needing to take no specific action other than those required to establish the linked multi-user group to result in this checking being performed. In a further optional embodiment of the present invention, the checking process can go even further, and when it is determined that the computers do not have compatible versions of the software applications installed thereon, can automatically install an update or a new version of the software application on one or both of the computers to enable them to share the application in the linked multi-user group. The user's explicit permission may or may not be required for such automated installation, depending on considerations such as the user's preferences and security needs. Once again, it should be appreciated that these optional embodiments of the present invention significantly facilitate and automate the formation of a linked multi-user group, as conventional prior art systems require that users manually locate and launch the application to be shared, and if it is determined that they do not have compatible versions of an application to be shared, the users must themselves manually address the situation to install appropriate applications on their computers and then attempt to reform the linked multi-user group.

As should be appreciated from the foregoing, there are numerous aspects of the present invention that each provides advantages over conventional systems for forming and maintaining linked multi-user groups. In accordance with one embodiment of the present invention, all of these various aspects of the present invention can be used together to provide a particularly robust system. However, it should be appreciated that the present invention is not limited in this respect. Specifically, each of the above-described aspects of the present invention, in and of itself, provides significant benefits over the prior art. Thus, each of these aspects of the present invention can be implemented separately, or any combination of these aspects of the present invention can be used together. Thus, the present invention is not limited to a system that employs all of the aspects of the present invention described above, nor to any particular combinations of these aspects of the present invention.

The embodiments of the present invention described above can be implemented in any of numerous ways, as these embodiments of the present invention are not limited to any particular implementation techniques. Therefore, although specific implementation details are described below, it should be appreciated that this description is provided merely for illustrative purposes, as numerous other implementations are possible.

In accordance with one illustrative implementation, various aspects of the present invention are enabled by a linker application installed on each of the computers used by users that can be joined together to form a linked multi-user group to share one or more software applications. The linker application is a software application which may be installed in a similar manner to that in which other software applications are installed on the user's computer. The linker application provides functionality which will be described in more detail below.

The linker application residing on the computer interfaces with client applications installed thereon. This interface can be accomplished in any of numerous ways, as the present invention is not limited to any particular interfacing technique, and may vary depending upon the client application. For example, if the client application is one with pre-existing capability for use in a linked multi-user group coded therein, the functionality provided by the linker application may differ than when the linker application interfaces with a software application having no such capability. As discussed above, for software applications having no capability encoded therein for use in a linked multi-user group, the linker application can interface therewith, for example, through a software plug-in or extension designed for use with software add-ons. Of course, it should be appreciated that this is merely an example, as software applications can also include customized code for interfacing with the linker application. As discussed in more detail below, in one embodiment of the present invention, the linker application has the capability of not only interfacing with software applications already installed on the associated computer, but also has the capability of automatically installing a new software application to be shared in a linked multi-user group, for example, by downloading the application over the Internet.

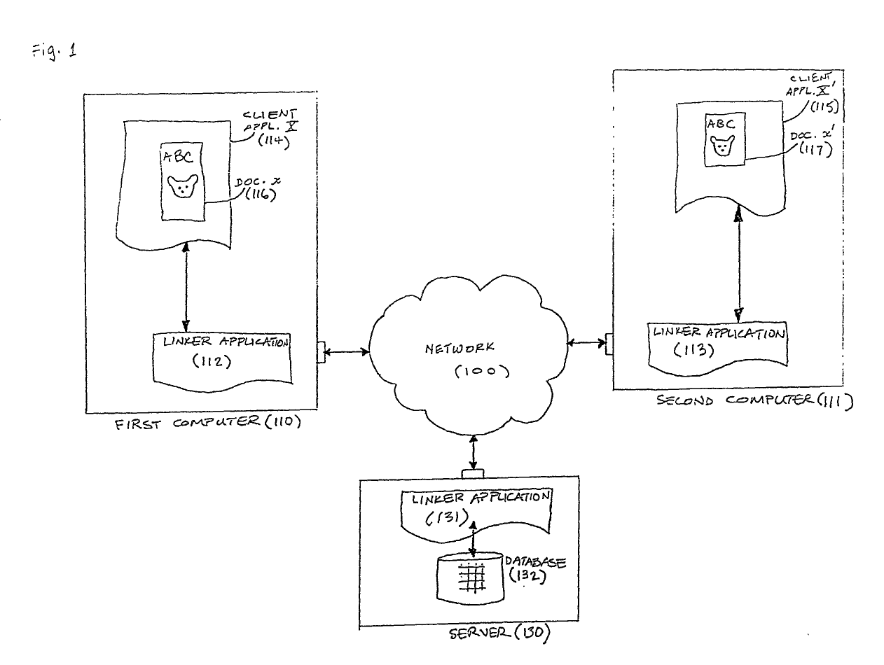

FIG. 1 is a block diagram of a computer system on which various embodiments of the present invention may be implemented. The computer system includes a first computer 110, a second computer 111, and a network 100 that couples the computers together. The network 100 may be any type of communication link suitable for coupling together the computers. For example, the network 100 may be wired or wireless, may be a local area network, wide area network, an open network, etc.

The first computer 110 has a client application 114 installed thereon. A document 116 of a type adapted for use with or generated by the client application 114 resides in storage or in memory on the first computer 110. In accordance with one embodiment of the present invention, the first computer 110 is provided with a linker application 112 for facilitating formation of linked multi-user groups to other computers on the network 100.

Similarly, the second computer 111 is provided with a linker application 113, which may or may not be identical to the linker application 112 on the first computer 110. Also, the second computer 111 is provided with a client application 115 installed thereon. An electronic document 117 is stored in storage or in memory on the second computer, and is adapted for use with or generated by the client application 115.

The client applications 114 and 115 are sufficiently compatible to enable them to be shared in a linked multi-user group. For example, client applications 114 and 115 may be copies of the same client application, having the same version numbers or build dates. Alternatively, client applications 114 and 115 may be of the same kind but differing in their version or build dates, with the differences not being of the type that prevents the applications from sharing or processing shared electronic documents in a linked multi-user group. As a further option, the client applications 114 and 115 may not be of the same kind. For example, the client applications may be from different vendors or may differ in other ways, such as the platform on which the client applications were developed or intended for use. As an example, client application 114 may be a web browser from one vendor (e.g., Netscape Navigator), while client application 115 is a web browser from a different vendor (e.g., Microsoft's Internet Explorer).

The electronic documents 116 and 117 are of a type intended for use with or created by their respective client applications 114 and 115, and in this sense correspond to their respective client applications 114 and 115. In some instances, the client applications 114, 115, may be capable of processing the corresponding electronic documents 116, 117 from their compatible applications. Documents 116 and 117 may be either identical or may at least share sufficient features as to allow for such compatibility.

In the system shown in FIG. 1, an additional server 130 is provided to facilitate linked multi-user group communication between users on the first and second computers 110, 111. The roles that the server 130 may play in this respect are discussed in more detail below. However, it should be understood that in one embodiment of the present invention, the server 130 only facilitates formation of a linked multi-user group, and is not in the data path and does not otherwise control communication between the linked users once the group is formed, such that communication between the multiple users is peer-to-peer. While such direct peer-to-peer communication is advantageous, it should be further appreciated that the present invention is not limited in this respect, and that the server 130 can take on even a greater role than facilitating linked multi-user group formation as discussed below, and can further be in the data path for information passed between the linked computers. Finally, it should be further appreciated that the present invention is not limited to a computer system that requires a separate server 130 to facilitate linked multi-user group formation, as other embodiments of the present invention can be implemented on a strict peer-to-peer system.

Establishing a Linked Multi-user Group

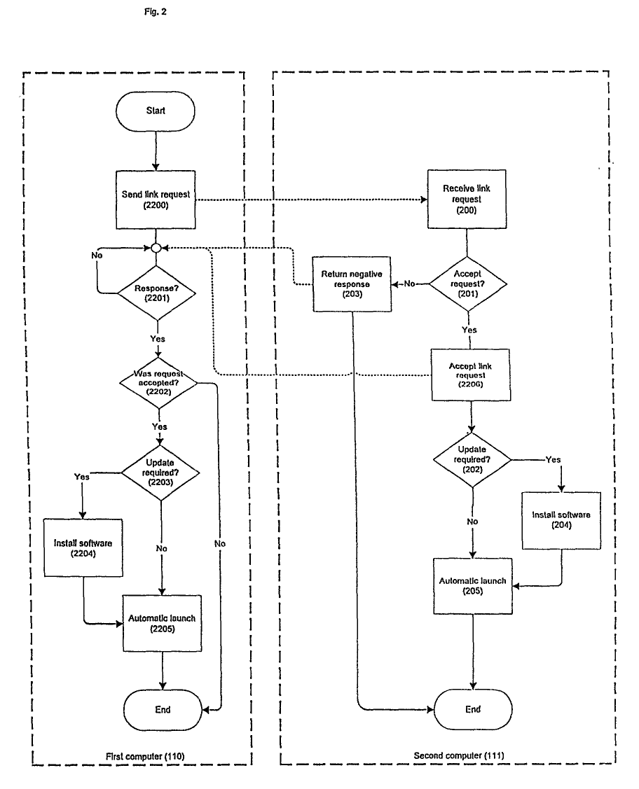

FIG. 2 illustrates schematically an exemplary sequence of events leading to the establishment of a linked multi-user group according to one embodiment of the present invention. It should be understood that the acts provided in the description below are given only for illustrative purposes, as it is not necessary to carry out all of the acts in every embodiment of the invention. Similarly, equivalent substitutions and modifications to some of the acts and to the order in which they occur are possible.

In the embodiment shown in FIG. 2, the process of forming a linked multi-user group between the first computer 110 and the second computer 111 is initiated by the first computer at act 2200, wherein the first computer sends a link request to the second computer requesting formation of a linked multi-user group. The manner in which the first user determines the network address (e.g., the IP address) to use to contact the second user is discussed below, and is one area where the server 130 (FIG. 1) can facilitate matters. The link request can take any of numerous forms, as the present invention is not limited to any particular form for the request.

In accordance with one illustrative embodiment of the present invention, the link request includes information identifying the user on the first computer that is requesting formation of the linked multi-user group, as well as information identifying a software application to be shared in the linked multi-user group.

In a further optional embodiment of the present invention, the identification of the application to be shared can be in the form of an icon that when selected by the receiving user, results in an automatic launching of the software application on the receiving user's computer (e.g., the second computer in FIG. 2). As used herein, the reference to an icon is intended to encompass any numerical, textual, graphical or other representation that is presented on a display of the second computer, and that when selected results in the automatic launching. Furthermore, the link request can be presented in such a manner that simply selecting the icon relating to the software application to be shared is interpreted as an acceptance of the request to form the linked multi-user group. It should be appreciated that this embodiment of the present invention is advantageous, in that it enables the user of the second computer to take only a single action in response to receipt of the link request to both accept the link request and automatically launch the associated software application.

It should be appreciated that the present invention is not limited to the use of link requests including the information and presentation discussed above, as the link request can be presented differently in other embodiments of the present invention. For example, the link request can include separate icons for the user on the second computer to select to: (1) accept the request for formation of the multi-user group and (2) automatically launch the associated software application. In a further alternative embodiment, the link request does not even identify any particular software application to be shared, such that the user on the second computer can simply accept the request to establish a linked multi-user interface, leaving to later communications over that linked communication channel to establish what software applications will be shared. Furthermore, although the automatic launching of the software application is an advantageous feature of some embodiments of the present invention, it is not a feature of every embodiment of the present invention.

As shown in FIG. 2, the link request is received at the second computer at act 200. Thereafter, a process running on the second computer proceeds to act 201, wherein a decision is made as to whether or not to accept the link request. When it is decided in act 201 to not accept the link request, the process proceeds to act 203, wherein a response is sent to the first computer indicating that the link request has been denied, and the process executing on the second computer terminates.

After sending the link request, a process executing on the first computer waits at act 2201 for a response. When a response is received, the process proceeds to act 2202, to determine whether the link request has been accepted. When the link request has been denied, the process on the first computer terminates.

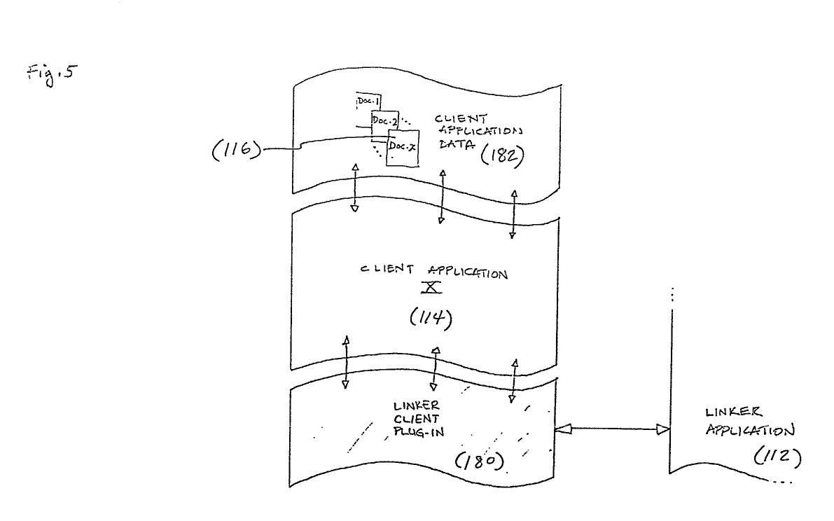

When it is determined at act 201 to accept the link request, the process executing on the second computer 201 proceeds to act 2206, wherein a response is transmitted to the first computer indicating that the link request has been accepted. The process then proceeds to act 202 to determine whether there is a software application identified in the link request that should be installed or updated so that the second computer has an installed software application compatible with that on the first computer. The determination in act 202 as to whether the software application identified in the link request should be installed or updated on the second computer can be performed in any of numerous ways, as the present invention is not limited to any particular implementation technique. Examples of how this can be accomplished are discussed in more detail below in connection with FIG. 5.

When it is determined that an installation or updating of the software application on the second computer is desired, the process proceeds to act 204, to perform the installation. This installation can be performed in any of numerous ways, as the present invention is not limited to any particular implementation technique, and can be performed manually by a user of the second computer, or automatically by the process in a manner transparent to the user. For example, the process executing on the second computer can go to an external server provided by the appropriate software vendor and download the desired software application or an update thereto. Alternatively, in the embodiment of the present invention wherein a server 130 (FIG. 1) is provided to facilitate the formation of linked multi-user groups, appropriate versions of any software applications available for sharing by linked multi-user groups on the computer system can be provided on the server 130 such that the process executing on the second computer can download the appropriate software program or update from the server 130. As a further option, the software to be installed can be passed from the first computer to the second computer.

When it is determined at act 202 that no installation or updating of the software application on the second computer need be performed, or after an installation at act 204, the process executing on the second computer proceeds to act 205, wherein the software application identified in the link request is automatically launched on the second computer, and the process then terminates. The automatic launching can be done in any of numerous ways, as the present invention is not limited to any particular implementation technique. For example, the linker application 113 can access information identifying where a software application is stored on the second computer (e.g., on a hard drive), and can call the operating system on the second computer to launch the software application.

When the process executing on the first computer receives a response (sent from the second computer process in act 2206) that the link request is accepted, it proceeds, through acts 2201 and 2202 in much the same manner as described above, to act 2203, to determine whether any installation or updates of the software application should be performed on the first computer. As with act 202 in the second computer process, this determination can be done in any of numerous ways, examples of which are disclosed in more detail below. When it is determined that an installation or update of the software application on the first computer is desired, the process proceeds to act 2204, wherein the installation is performed in much the same manner as described in connection with act 204 on the second computer.

When it is determined in act 2203 that no installation or update is required to the software application on the first computer, or following the installation/updating at act 2204, the process on the first computer proceeds to act 2205, wherein the software application is automatically launched on the first computer (in a manner analogous to act 205 discussed above), and the process then terminates.

It should be appreciated from the foregoing that the embodiment of the present invention shown in FIG. 2 includes a number of advantageous but optional features that are not necessary for every embodiment of the present invention. As discussed above, it is not required for every embodiment of the invention that the link request even identify any software application to be shared. Obviously, for those embodiments where the link request does not include identification of an application to be shared, the acts relating to checking the compatibility of the software applications and automatically launching them need not be performed. Furthermore, while the automatic checking illustrated in FIG. 2 to determine whether the software applications on the first and second computers are compatible is advantageous, this is also an optional feature, and is not required in every embodiment of the present invention. The same is true of the automatic launching feature. Thus, even where the link request includes an identification of a software application to be shared, not every embodiment of the present invention requires that the software application be automatically launched on the first and second computers, as the launching can be done manually by the users.

As should be appreciated from the foregoing, the method for initiating formation of a linked multi-user group shown in FIG. 2 is begun by a first user (i.e., on the first computer) sending a link request to a second user (i.e., on the second computer), and the link is established upon acceptance of the request by the user on the second computer. This differs from conventional techniques for forming a linked multi-user group, which requires the creation of a lobby, and then that each user enter the lobby prior to launching the software application to be shared.

In the embodiment of the present invention shown in FIG. 2, the process executing on the first computer does not launch (in act 2205) the software application to be shared unless and until the request for forming a linked multi-user group is accepted by the user on the second computer. It should be appreciated that the present invention is not limited in this respect, as this can be done in other ways. For example, the user on the first computer can launch the application thereon prior to sending the link request at act 2200.

Illustrative User Interface for Link Formation

Various user interfaces can be employed to facilitate the users on the first and second computers in performing their actions of sending (act 2200 on the first computer) and accepting/refusing (acts 201, 203 and 2206 on the second computer) the link request in the formation method of FIG. 2.

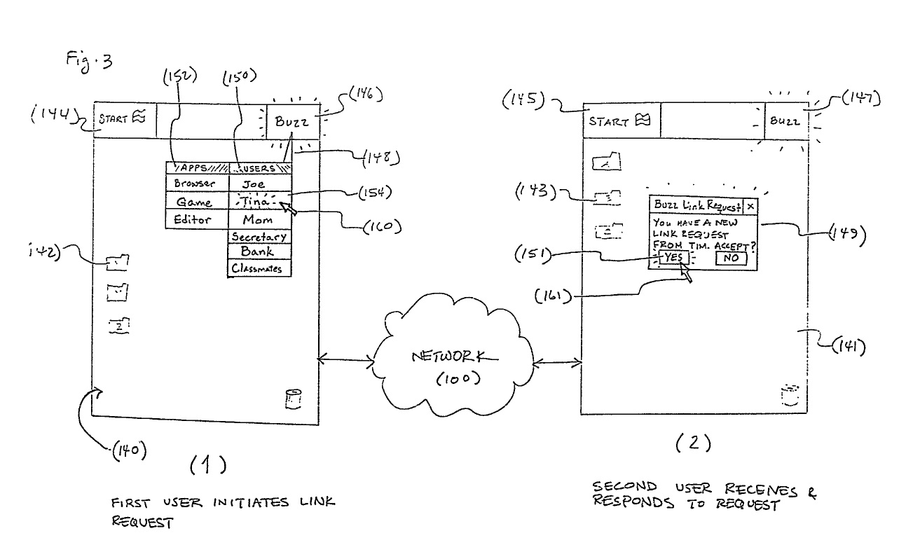

FIG. 3 shows an example of a user interface for both the link request sender and receiver according to one embodiment of the invention. In this illustrative example, the computer of a first user (e.g., the first computer 110 in FIG. 1) has a graphical user interface with a desktop 140, some desktop icons 142 and a taskbar 144, which includes an icon 146 to initiate linked multi-user groups. The first user in this example initiates the formation of a linked multi-user group by moving his cursor 160 to the icon 146 and selecting the icon, which is associated with a drop-down menu, e.g., by clicking on it. In this embodiment, lists of users 150 and applications 152 which are available for participation in a linked multi-user group appear in the pull-down menu. The first user can move his cursor 160 onto the name of the application or user with which he wishes to establish a link. For example, by selecting a particular user name 154 from the list of users 150 (and optionally an application from the list 152), a link request can be automatically sent over the network 100 to the selected user 154.

A second user (e.g., on the second computer 111 in FIG. 1) identified by the selection 154 receives the link request. An indication, which may be visual, audible, or otherwise, announces the request's arrival. For example, the second user's computer can have a graphical user interface with a desktop 141, various desktop icons 143 and a taskbar 145. In such an interface, a linker icon 147 can change color, flash or appear to indicate an incoming link request. Alternatively, a pop-up window 149 may appear on the desktop 141 of the second user's computer. The pop-up window 149 may contain a message announcing the incoming link request. The pop-up window 149 may also comprise one or more icons 151 or objects that are selectable by the second user.

In the embodiment shown, the pop-up window 149 displays a link request message and presents the second user with on-screen icons (e.g., buttons) to accept or reject the link request. An “Accept” button 151 may display text such as ‘OK’, ‘Yes’, or ‘Accept’, and a “Reject” button may display ‘Reject’, ‘Decline’, ‘No’, etc. Thus, the single act by a user of the second computer of selecting one computer screen icon can result in establishment of the linked multi-user group, and may optionally also automatically launch a resident client application, and as an additional option may automatically install the application prior to launching as discussed above. In addition to rejecting the link request in response to an affirmative act by the second user, one embodiment of the present invention can also include a time out feature, wherein the link request is automatically rejected if not accepted within a specified period of time. Of course, it should be appreciated that the present invention is not limited in this respect, and that no time-out feature is required.

The example provided above is given for illustrative purposes only, as variations of the interfaces are possible. For example, in the illustrative example shown in FIG. 3, the pop-up window 149 does not display the name of a client application for which the link request is requested. As discussed above, in an alternate embodiment of the invention, this information can be included on the display screen of the computer used by the second user (e.g., by being included in the pop-up window 149).

In one embodiment of the invention, security preferences may be set in place by a system administrator, or by a user himself. For example, a user's computer may be set to automatically reject all link requests from certain other users or from all other users, if the link request recipient's computer is in a high-security mode or if the linker application 112, 113 is set to a ‘Do Not Disturb’ mode. Of course, the present invention is not limited to using these or any other security preferences.

In one embodiment of the present invention, a repository or registry (e.g., a data file) is kept to identify all link-enabled applications residing on the computer. For example, whenever a link-enabled client application is newly installed or upgraded on the computer, a new corresponding or updated entry may be made in the linker registry to note this event. Similarly, if a client application is made link-enabled by later installing a linker-client plug-in 180 to that client application, the registry may be updated as described above. The maintenance of a registry of link-enabled client applications may allow for reduced errors in the user attempting to request linking of an application that is not link-enabled, and can provide a source of data to be adapted for presentation to a computer user (e.g., as shown at 152 in FIG. 3), indicating which client applications the user may form links with. Although advantageous, it should be appreciated that all embodiments of the present invention are not limited to use of a registry of linked-enabled client applications.

Illustrative Link/Unlink Request Format

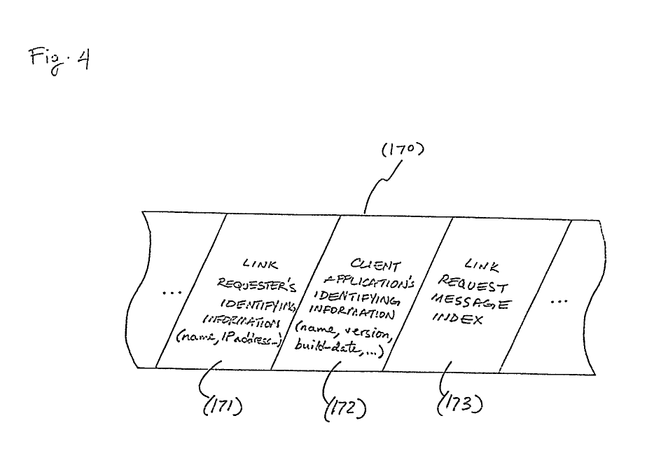

The exact format of a request to form a link, or to remove a user from an established multi-user group as discussed in more detail below, can vary, as the present invention is not limited to any particular format. FIG. 4 shows conceptually a representation of a segment of an electronic link request 170. The figure illustrates three exemplary information components included in the link request 170. First, information identifying the sender of the link request is included in the link requestor's identifying information 171. This may include any of several types of data, including a unique peer identifier (e.g., assigned by the server 130 in FIG. 1) that is unique for each user available for participation in a linked multi-user group, the IP address of the requestor, and a nickname of the requestor to be displayed to the other users. Second, link request 170 optionally further includes client application identifying information 172. The client application identifying information 172 may include information identifying a focused client application which the requestor has opened, and is requesting that the recipient link to immediately upon acceptance of the link request. The information identifying the focused client application may optionally include the name of the application, as well as additional information (e.g., the version of the client application, the build-date of the client application, etc.) that may be used to determine compatibility between the application and the corresponding application on the recipient computer as discussed below. In accordance with one embodiment of the invention, the client application identifying information 172 also may optionally include identifying information relating to other link-enabled applications that the requesting user currently has launched, and may wish to switch into during the linked multi-user session. Third, the link request message 170 may also include a link request message index 173 that can be used in accordance with one embodiment of the present invention to facilitate multi-user group formation as discussed below.

While not shown in FIG. 4, two other fields may also be included in a link or unlink request. First, a field can be provided to identify whether the request is seeking to establish a link, or to remove the sending user from an already established link. In addition, in accordance with one embodiment of the present invention, an automatic linking field can also be provided, wherein the requester informs the recipient to automatically accept the link, without giving the recipient the option to deny the link request. This can be used, for example, in some secure environments (e.g., a same office environment), where security is less of a concern. Of course, this is an optional feature of the present invention, and need not be provided at all.

It should be appreciated that the above example of the type of information included in the link/unlink request is provided merely for illustrative purposes, as not all of this information need be provided in every embodiment of the present invention, and further in view of the fact that other data may also optionally be included.

Discovery of Recipient User's Location

As mentioned above, the embodiment of the present invention shown in FIG. 1 includes a server 130 that is used to facilitate the formation of linked multi-user groups. In this respect, it should be appreciated that several embodiments of the present invention are directed to the formation of a linked multi-user group that is initiated by one user in the group transmitting a link request to another user. In order to do so, the user that transmits the link request identifies where the recipient user is on the network 100, so that the link request can be provided with information that enables the network 100 to route the request to the recipient computer (i.e., the second computer 111 in the example of FIG. 1). In one embodiment of the present invention, the linked multi-user groups can be formed over a network 100 that includes the Internet. As such, the information identifying the destination of the computer receiving a link request can be provided as an Internet Protocol (IP) address. It should be appreciated that IP addresses need not be maintained consistently over time, such that each time the user of the second computer turns the computer on, it is possible that the second computer will be assigned a different IP address.

In view of the foregoing, in one embodiment of the present invention, the server 130 is provided to assist a computer that wishes to issue a link request (e.g., the first computer 110 in the example of FIGS. 1-3) in locating the destination of its desired recipient for the request (e.g., the second computer 111 in the example above). In accordance with one embodiment of the present invention, the server 130 is provided with a public URL (e.g., www.buzzpad.com) that is always accessible to the users of the network 100. Thus, in accordance with this embodiment of the present invention, when the first computer 110 wishes to send a link request to the second computer 111, the first computer 110 first undertakes a discovery process to determine the location of the second computer 111 by querying the server 130. In this respect, in one embodiment of the invention, each of the computers that is on-line in the computer system and has a linker application (e.g., 112, 113 in FIG. 1) goes through a startup process when the computer is turned on that will include communicating with the server 130, with the result that the server 130 will know the IP addresses of all of the multi-user link-enabled computers in the system. Thus, when the first computer 110 queries the server 130 for the destination address of the second computer 111, the server 130 will return an IP address to the first computer 110 that includes the last known IP address for the second computer 111. Thus, if the second computer has not been turned off, it will still be located at the IP address known to the server 130, such that the first computer 110 can send the link request to that IP address, and the link request will be received if the second computer 111 is on-line.

As should be appreciated from the foregoing, in the above-described embodiment, the server 130 merely serves the purpose of enabling the multi-user link-enabled computers in the computer system to discover the location of the other computers in the system, but is not otherwise involved in the establishing and maintaining of a linked multi-user group, nor in controlling the flow of information between users in a linked multi-user group.

While the server 130 is provided in some embodiments of the present invention to facilitate discovery of a recipient user's address, it should be appreciated that the present invention is not limited in this respect, and that in some embodiments of the present invention the server 130 need not be provided. For example, in embodiments of the present invention wherein the multi-user link-enabled computers maintain constant addresses accessible over the network 100, the server 130 is unnecessary, as the users can exchange information once (e.g., using other communication means such as a telephone), and each computer can store information identifying the destination of users with which it is interested in forming linked multi-user groups. Conversely, even in a situation wherein destination addresses may be subject to change when a computer is turned off, the server 130 is not required, as users can keep their computers turned on so as to not change their destination addresses, or users can take their chances that even when a computer is turned off and on, it will be reassigned the same destination address, and in the event that that fails, can then establish through other communication channels (e.g., a telephone) what the destination address is of any computer to which a link request is to be sent.

An additional level of complexity is encountered when one of the computers that participates in a linked multi-user group is contained within a firewall. A firewall typically is implemented as a server whose function includes shielding a portion of a computer system from access (typically over a network) from other computers outside of the protected system. Conceptually, the server can be considered as a firewall that blocks access into a particular computer system from the outside. One aspect of most firewalls is that they provide security, in part, by preventing users outside of the firewall from directly accessing the identity or location of computers within the firewall, such as their unique IP addresses. Thus, one characteristic of most firewalls is that they will prevent access to a computer within the firewall from outside of the firewall, unless and until the computer within the firewall has initiated communication with a particular outside computer. In this respect, most firewalls follow the premise that if a computer inside of the firewall has initiated communication with a computer outside of the firewall, that outside computer can be trusted to send back responsive communication to the protected computer inside the firewall.

In view of the foregoing, if one of the computers to be formed in a linked multi-user group is inside a firewall, and the others are outside, in one embodiment of the present invention, a linked multi-user group can be formed by having the computer inside the firewall initiate the link request, which will then enable the outside computers to respond, and the firewall will let those responsive communications pass through to the initiating computer.

In accordance with an alternate embodiment of the present invention, a technique is employed to allow any of the computers in a system to initiate a linked multi-user group, even if one of the computers is inside a firewall. This embodiment of the invention can be implemented using a server or other computer (e.g., this can be implemented on the server 130 in FIG. 1) that is outside of the firewall and is referred of as a reflector. As part of the initialization routine for the computer within the firewall when it is started up, the corresponding linker application 112, 113 transmits a communication to the reflector server, which will then have the capability of sending responsive communications back to the computer within the firewall. In addition, the computer within the firewall will register with the server 130 (see the discussion of the discovery process above) indicating that attempts to establish a linked multi-user group with the computer within the firewall should be sent to the reflector server. A link request from one of the computers outside of the firewall to the reflector server is then routed by the reflector server to the computer within the firewall, thereby enabling the computer within the firewall to be included in a linked multi-user group initiated by a computer outside of the firewall. It should be appreciated that once the computer within the firewall sends a communication directly to the other linked users outside of the firewall, those users outside of the firewall will then be able to send responsive communications back directly to the computer within the firewall, and need not route every communication through the reflector server.

It should be appreciated that the embodiment of the present invention that employs a reflector server can also be used to facilitate the formation of a linked multi-user group between two computers are behind different firewalls, as each of the computers can access the reflector server, and the reflector server can route communications back to the computers within the firewalls.

It should be appreciated that while one embodiment of the invention employs the reflector server to provide the advantages described above, it should be appreciated that the present invention is not limited to employing a reflector server, as it is not necessary for use in every embodiment of the present invention.

Software Interface

FIG. 5 shows one possible representation of the relationship between the various software components described above. In this example, which is given for illustrative purposes only, a client application 114 has associated client application data 182, e.g., in the form of electronic documents 116. The client application 114 is coupled to the linker application 112 by way of a software linker-client plug-in 180. The linker-client plug-in 180 may be specifically adapted for use with the client application 114, or may in some instances be generic, and suitable for use with a variety of different client applications. In one embodiment, the linker-client plug-in 180 is a software extension which is written in a programming language and compiled along with the client application 114 at build time, so that the plug-in 180 essentially acts as a part of the client application 114. In another embodiment, the plug-in 180 is separately compiled and then associated with the client application's executable program. Data 182 related to the client application 114 is exchanged via the linker-client plug-in 180 with the resident linker application 112 on the computer. The linker-client plug-in 180 may perform a variety of tasks on the exchanged data or may merely pass the data unaltered between the client application 114 and the linker application 112.

Automatic Compatibility Checking

As discussed above, in one embodiment of the invention, automatic checking of the compatibility of the software applications is performed when forming a linked multi-user group between at least two computers (e.g., the first and second computers 110, 111 of FIG. 1). This can be done in any of numerous ways, as the present invention is not limited to any particular implementation technique. For example, in addition to identifying a particular software application to be shared, a link request can include version/revision information, which the receiving computer can compare (e.g., in act 202 in FIG. 2) to determine whether the software application on the receiving computer is up to date. Similarly, when the receiving computer provides an acceptance (at act 2206) of the link request, it can include information relating to its version/revision of the software application, which the process executing on the requesting computer can examine to determine (e.g., at act 2203 in FIG. 2) whether updates are needed to the software application on the first computer.

The information identifying a version/revision of the software application can be provided in any of numerous ways, as the present invention is not limited to any particular implementation. In accordance with one embodiment of the present invention, a multi-user link-enabled application (or its associated linker plug-in 180, as shown in FIG. 5) is assigned identification information that defines not only the client application, but also a class of versions/revisions thereof that are pre-determined to be compatible for use in a linked multi-user group. Therefore, when a link request is received at a computer (e.g., the second computer 111) with matching identification information, the receiving computer recognizes (e.g., in act 200 in FIG. 2) from this match that the installed versions/revisions of the client applications are compatible.

Of course, alternate implementations are also possible. For example, each user's computer can be provided with a look-up table or other stored list for each of its multi-user link-enabled applications to correlate which versions/revisions of the same or other client applications are compatible therewith. Thus, when a link request is received identifying a particular application, the look-up table can be referenced to determine whether the receiving computer has a compatible client application installed thereon. As should be appreciated from the foregoing, client applications can be considered to be compatible (and therefore, can share common identification information or can be cross-referenced in a look-up table) even if the applications are different (e.g., are provided by different software vendors).

It should be appreciated that the above-discussed examples for implementing a checking of compatible software applications are provided merely for illustrative purposes, as this aspect of the present invention can be implemented in numerous other ways.

Decentralized Linked Groups

As indicated above, in one embodiment of the present invention, the list of users in a linked multi-user group is distributed among all of the users in the group, as opposed to being consolidated at a centralized server. In the illustrated examples discussed above in connection with FIGS. 1-3, the linked multi-user groups include only two users. However, it should be appreciated that the present invention is not limited in this respect, and that linked multi-user groups of any number can be created using any of the embodiments of the present invention discussed herein. In the examples discussed above, wherein there are only two users, the process of distributing the complete user list amongst all the users is quite simple, as each user simply is aware that it is linked to the other. When additional users are added, the process is only slightly more complex.

As indicated above, in accordance with one illustrative embodiment of the invention, a new user can be added to an established linked multi-user group by submitting a link request to any of the users in the group. Once a link has been formed between the new user and one of the users in the established linked multi-user group, the knowledge of the new user is spread about the group, and the identities of the other users in the group are passed to the new user, so that every user in the newly expanded linked multi-user group maintains a complete list of all of the users in the group. This propagation of information can be accomplished in any of numerous ways, as the present invention is not limited to any particular implementation technique. One implementation example is described below, solely for illustrative purposes, as numerous other implementations are possible.

As an example, assume that a linked multi-user group is established between two users, identified as user A and user B. Next, a third user (user C) submits a link request (in much the same manner as described above) to form a linked multi-user group with user B. When user B accepts the link request, a link is automatically formed between user B and user C. User B can then transmit a request to either of users A and C, requesting that they link together. The user that receives that request can submit a link request to the other, and when the link request is accepted, enlargement of the linked multi-user group is completed, with the three users A, B, C being linked together, and with each of the users having a complete list of the other users in the linked multi-user group.

It should be appreciated that using similar techniques, it is possible to also completely interconnect two or more previously-established linked multi-user groups. This can be accomplished initially by a user from one of the groups submitting a link request to a user from the other group, such that when the link request is accepted, a bridge between the two groups of users is created. Thereafter, in a manner similar to that described above, the bridging users then pass information between themselves, identifying each of the other users in their respective groups. Then, the users that receive this information initiate link requests to the users in the other previously-established group, to create a completely interconnected larger group of users. Again, it should be appreciated that this description is provided merely as an example, as numerous other implementations techniques for interconnecting two previously-established linked multi-user groups are possible.

It should be appreciated that when a user removes himself/herself from an established linked multi-user group, the knowledge of the user leaving the group can be spread about the group in much the same manner as described above, so that every user in the newly contracted linked multi-user group has an updated and accurate list of all of the users in the group. This propagation of information can be accomplished in any of numerous ways, including any of the ways discussed above for transmitting information when a new user is added, as the present invention is not limited to any particular implementation.

It should be appreciated that users may add themselves to an established multi-user group, remove themselves, then re-add themselves to the group again at a later point in time. It should be appreciated that network latency and potentially lost communications over the network may cause messages to arrive at different times, and out of order. In accordance with one embodiment of the present invention, a technique is employed to ensure that all users ultimately recognize the same group of linked users, irrespective of the order in which various requests adding or removing a user arrive at each of the other users. This can be done in any of numerous ways, as the present invention is not limited to any particular implementation technique. However, in accordance with one illustrative embodiment of the invention, an indexing scheme is employed, wherein each link request message includes a link request message index 173 as discussed above in connection with FIG. 4, and each request to remove a user includes a similar message index. The indices are user-specific, and track the order of the requests passed from that user to the other users in the group. Thus, as a group of multiple users passes the user list for the group among the multiple users, it keeps track of the last command index received from each user. Thus, when a user receives a new user list from another user, the associated command index for the new user list is compared against the command index for the user list most recently received from that user. A new user is then only added to or removed from the user list if the newly received request has a higher command index than that previously received. Thus, even if the commands adding or removing a user arrive out of order, every user in the group will have a consistent user list.

Thus, it should be appreciated from the foregoing that one embodiment of the present invention enables users to be dynamically added to an established linked multi-user group without disbanding the established group, such that the users linked together in the established group can maintain continuous linked multi-user communication.

The embodiments of the present invention described above that relate to the formation and maintenance of decentralized linked multi-user groups can be implemented in any of numerous ways. In one embodiment of the present invention, the communication that results in the formation and maintenance of the linked multi-user groups is performed in a peer-to-peer manner. However, it should be appreciated that the present invention is not limited in this respect, and that decentralized linked multi-user groups can also be formed in a client-server architecture.

Shared Web Browser Application

An example of a client application that can be shared in a linked multi-user group using the various embodiments of the present invention discussed herein is a WorldWide Web browser (hereafter web browser), which is a software application that enables computer users to access information on the Web. As discussed above, although web browsers conventionally enable multiple users to simultaneously view, and in some particular cases interact with by entering data on, a website, conventional web browsers do not enable two or more users to form a linked multi-user group, because the data set used in those applications is centrally stored on one or more web servers, and is not distributed among the multiple users, thereby preventing the sharing of web pages in a collaborative manner as enabled by various embodiments of the present invention.

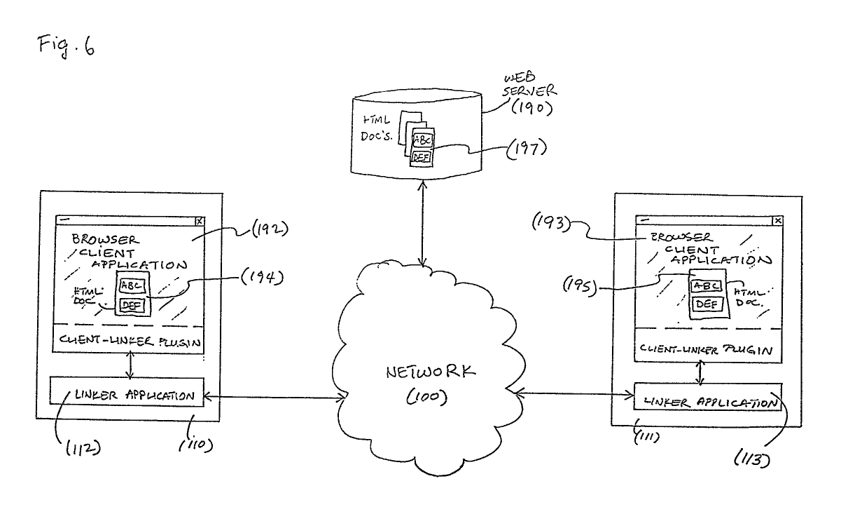

FIG. 6 illustrates a computer system including first and second computers 110 and 111 interconnected via a network 100, and further including a web server 190. In the system shown in FIG. 6, the first computer 110 has a first browser 192 running thereon, and the second computer 111 also includes a web browser 193 running thereon. The web browsers 192, 193 are capable of accessing HTML or other such compatible electronic documents 197 residing on the web server 190. It should be appreciated that the embodiment of the present invention that enables linked multi-user web browsers can be used with any present or future formats and data file types, and is not intended to be limited to existing HTML file formats.

The web browsers 192 and 193 each has a client-linker plug-in, 180 and 181 respectively, that enable the web browser to be shared in a linked multi-user group according to various embodiments of the present invention as described above, including through the use of linker applications 112, 113. In the state of the system shown in FIG. 6, a linked multi-user group has already been established between the web browsers 192, 193, and a copy 194 of an electronic document 197 has been downloaded (over the network 100) from the web server 190 to the web browser 192 executing on the first computer 110. In addition, as a result of the formation of the linked multi-user group, the web browser 192 transfers a copy 195 of the electronic document to the web browser 193 on the second computer.

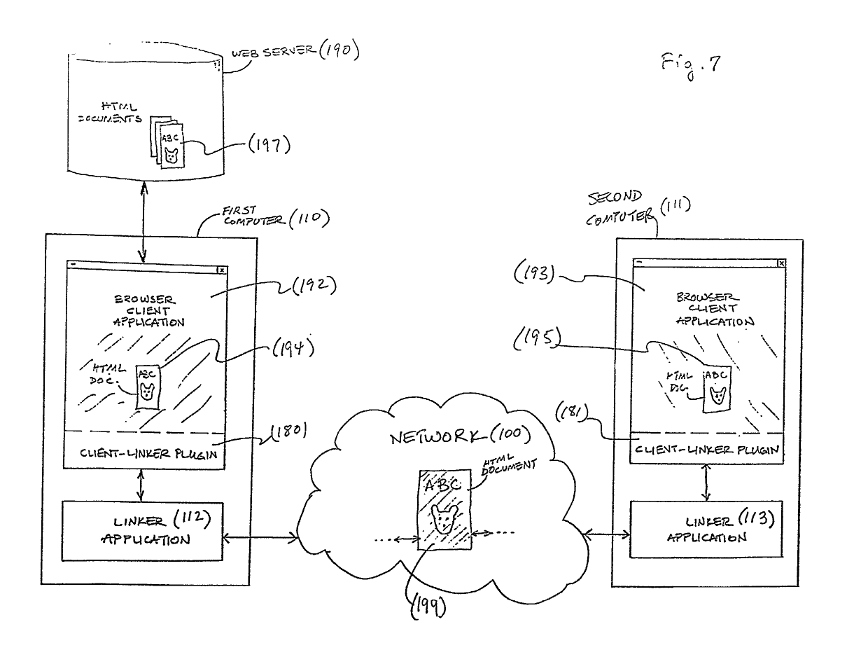

Thus, according to the embodiment of the present invention shown in FIG. 6, the electronic document 197 has copies 194, 195 thereof resident on both the first and second computers 110, 111, in association with their respective web browsers 192 and 193. While copies 194, 195 are resident on both the first and second computers, it should be appreciated that the web server 190 downloads a copy of the electronic document 197 to only one of the web browsers, e.g. 192, and it is the web browsers themselves (which are shared in a linked multi-user group) that transfer the copy of the web document from one of the web browsers to the other. This is conceptually illustrated in FIG. 7, wherein the web server 190 is shown as being directly coupled only to the web browser 192 on the first computer 110. It should be appreciated that FIG. 7 is meant to merely illustrate the data flow path of the web server 190 directly downloading a copy of the electronic document 197 to the web browser 192, and not to indicate a direct connection between the first computer 110 and the web server 190, as that connection typically will be through the network 100.

As indicated above, through the linked multi-user group formed in accordance with the various embodiments of the present invention discussed above, the web browsers 192, 193 are shared, as is the electronic document 194, 195 (e.g., web page) operated thereon. Thus, the web browsers 192, 193 and their associated documents 194, 195 are synchronized, such that any updates made via one of the web browsers 192, 193 to its copy of the electronic document are automatically and immediately transmitted to the other web browser. Thus, the electronic document 194, 195 can be thought of as not being resident on any single one of the web browsers 192, 193, but can conceptually be viewed as an electronic document 199 (FIG. 7) resident on a single browser shared between the users of the multi-user group. This communication is peer-to-peer, because no one computer owns a definitive copy of the document at any time, and furthermore, because the document can migrate across users through time, as other users join or leave the established multi-user group.

In one embodiment of the present invention, whenever one of the web browsers 192, 193 makes a change to its resident copy 194, 195 of the shared electronic document 199, it immediately transmits the entire updated document to the other web browser, to maintain coherency between the copies 194, 195 of the electronic document. However, it should be appreciated that the present invention is not limited in this respect, as in another embodiment of the present invention discussed below, less than the entire document (e.g., only the portions of the electronic document (or portions thereof) actually updated) can be transmitted to reduce the amount of information transmitted between the web browsers 192, 193. It should be appreciated that the transmissions of the document (or portions thereof) between the web browsers 192, 193 can be accomplished in any manner, as the present invention is not limited to any particular transmission techniques, and can optionally use encryption or other security measures if desired. The particular manner in which the sequencing and coordination of the data exchange between the web browsers 192, 193 is accomplished is not a limitation of the present invention, as any suitable technique for exchanging data in a linked multi-user application can be employed. Examples of a handful of suitable techniques are provided below.

As discussed above, there are conventional utilities that enable two users to achieve some level of sharing of access to a web page. However, those utilities are not linked multi-user groups, as the data set is not distributed, with all updates to any copy of the web page being performed only at the web server, and with all downloads of the web page to any of the sharing browsers being direct from the web server. By contrast, the embodiment of the present invention described above in connection with FIGS. 6-7 is directed to a linked multi-user group that enables a significantly more robust sharing of the web page or other electronic document.

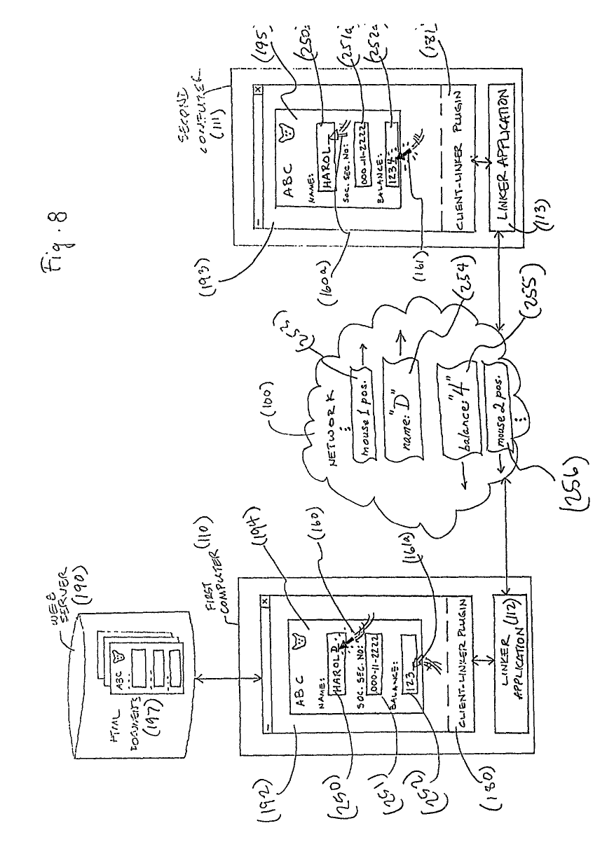

One illustrative embodiment of the present invention is directed to implementing a linked multi-user group between two web browsers, wherein the shared document is maintained consistently on the two web browsers by sending less than the entire document between the web browsers when the document is updated. This embodiment is illustrated conceptually in FIG. 8. In the system of FIG. 8, a linked multi-user group has been formed between browsers 192, 193, with a copy 194 of an electronic document 197 having been transmitted from the web server 190 to the web browser 192, and with the first web browser 192 having transmitted a copy 195 of the electronic document to the web browser 193. The electronic document 194, 195 may be, for example, an HTML document that may contain several fields, such as those found in electronic on-line forms intended to be filled in by a user. For example, a user on the first computer 110 may be filling out an application document 194 that has a text box 250 for Name, another text box 251 for Social Security Number, and a third text box 252 for an Account Balance Amount. The first user may interact with the document 194 in any suitable way for filling in such text boxes.

The user of the second computer 111, via the second browser 193, can collaboratively interact with (e.g., view, enter data, move cursor, etc.) its copy 195 of the electronic document simultaneously with the first user. Data may be exchanged between the two copies 194 and 195, such that each of the users is viewing a substantially up-to-date version including the user's own edits and entries, and the edits and entries of the other user(s) in the linked multi-user group.

For example, if the user of the first computer 110 types a character (‘D’) into the Name text box 250, that character 254 may then be transmitted, optionally with information describing the object (i.e., the Name text box) to which it belongs, to the web browser 193 on the second computer 111. Upon receipt, the web browser 193 uses the identifying information to place the character (‘D’) into the appropriate position in the Name text box 250a of its local copy 195 of the electronic document to maintain the coherency between the copies of the document distributed between the web browsers, 192, 193. Likewise, if the user of the second computer enters a number into the Balance text box 252a on his local copy 195 of the document, this character (‘4’) can be transmitted (along with information identifying the character as being entered in the Balance text box) back to the first computer 110, where the web browser 192 updates its local copy 194 of the electronic document accordingly.

Thus, several techniques are provided for collaboratively sharing a document, such as a Web page, according to various embodiments of the invention. The entire document may be exchanged and updated, portions of the document, such as HTML code, may be collaboratively exchanged and edited, and/or only the non-code user-editable data elements (e.g., input fields) may be exchanged.

In another embodiment of the invention, two linked users can collaborate on the data contents of a Web page, with the copies of the Web pages on the browsers in the linked group including different information. For example, one of the Web pages can include a subset of the data on the other, with only the portions of the Web pages that are in common between the two pages being synchronized and shared. For example, a patient and a health care provider may access and collaborate online with respect to some Web page entries while not sharing other entries, such as security-related entries depending on permission level or identity. The exact format of the Web page seen by the patient may differ from that seen by the healthcare provider, but some common data elements can be shared and synchronized.

Distributed Shared Data Set

As indicated above, the present invention is not limited to any particular manner of sequencing and coordinating the data exchange between multiple users sharing a distributed data set, as this can be accomplished in any of numerous ways. In accordance with one illustrative embodiment of the present invention, the shared data set is structured as a database of named objects. For example, the data set can be broken up into objects with unique string names, with the objects being any of numerous types (e.g., integers, strings, floats, etc.). Wrappers can be used to combine these basic types to build more complex objects, which can then be ordered and structured into a hierarchy within the database. The database can be represented as an XML document or in any other way. Of course, it should be appreciated that the present invention is not limited to organizing the shared data set as a database having the above-described characteristics, as numerous other alternatives are possible.

In terms of maintaining synchronization between multiple copies of the distributed data set, numerous techniques can be employed. Three examples are described below. However, it should be appreciated that the present invention is not limited to using these or any other particular techniques.

First, a no resolution technique can be employed. This is a straightforward implementation, in which the system makes no attempt to resolve conflicts. Thus, each user may update his/her local copy of the shared data set whenever he/she desires, then those updates are transmitted to the other users. If multiple users attempt to change data at the same time, no attempt is made to resolve conflicts so that the various copies of the shared data set may become out of synchronization. The benefit to this no resolution technique is that it is extremely fast and simple, and uses minimal bandwidth. However, the disadvantage is that it does not guarantee synchronization at all times. This technique may be particularly useful for applications in which synchronization is not critical, or for objects within a shared data set that change in value often, such as cursor pointers. In this respect, for values that change often, if the object is out of synchronization at some point in time, this will be quickly corrected the next time the object (e.g., the cursor pointer) is updated.

A second technique is referred to herein as version resolution. In accordance with this technique, each user tracks a version index for each object. Any user may update the object, and increase its version index by one, and then send out the update to all of the other users. When a user receives an object update message with a version index higher than the one stored in the local copy of the shared data set, the user updates its copy of the data set. Of course, it is possible that two users may update their local copies of the shared data set simultaneously. If that occurs, the other users may receive two different objects with the same name and version index. In accordance with one implementation, each peer resolves the collision based upon the unique identifier assigned to the users, such that each of the users has a unique identifier that is ordered with respect to the others. For example, a user with a user identifier equal to one will always be selected to dominate in a collision with a user with a higher user identifier (e.g., user two); user two will lose in a collision with user one, but dominate in a collision with all other users, etc. Since all of the users will know the unique identifier of the user making a change, all users can resolve the conflict in the same manner, resulting in a deterministic solution.

A third option employs a full lock/unlock technique, which is a commonly used technique for safely changing multiple copies of a shared database. Using this technique, before a user can update its local copy of a shared data set, the user must request from all of the other users a lock on the data object to be changed. Only after all of the other users have granted the lock is the user free to change the object value. Once the user has changed his/her local copy of the data set, the change is then broadcast to all of the other users. Only after all of the other users have confirmed that they have updated their local copies of the data set with the change does the changing user release the lock on the data object, thereby enabling other users to change the object. Although this method ensures that the database remains completely in synchronization across all of the users at all times, it is slower and requires more communication between the users than the other techniques discussed above.

As indicated above, it should be appreciated that the present invention is not limited to the use of any of these techniques, as other options are possible. In addition, it should be appreciated that hybrid techniques are possible, wherein different ones of these techniques are used for different objects in a shared data set. For example, the no resolution technique can be employed for cursor pointer updates, with the full lock/unlock technique being used for data objects for which constant synchronization is more critical.

Linker Transport Layer

In accordance with one embodiment of the present invention, a linker transport layer is created to facilitate communication between users in establishing, maintaining and sharing communication in a linked multi-user group. The linker transport layer can establish communication links between the linked users using any of a variety of techniques (e.g., UDP, TCP, HTTP tunneling, etc.), as the present invention is not limited to the use of any particular technique. The communication path used by the linker transport layer may include reflectors as discussed above, as well as intermediate routers or other communication techniques. It should be appreciated that the use of a linker transport layer is advantageous, in that it provides a layer of abstraction that is independent from numerous variables that are dependent upon the environment for the particular users. In this way, the linker transport layer facilitates communication at the linked multi-user group level, and is independent of different communication techniques that may be used by the various users due to firewalls, network address translator, and other network components. The shared data set can run on top of the linker transport layer. Of course, it should be appreciated that the present invention is not limited to the use of a separate linker transport layer, as the embodiments of the present invention disclosed herein can be implemented in other ways.

Additional Communication Link

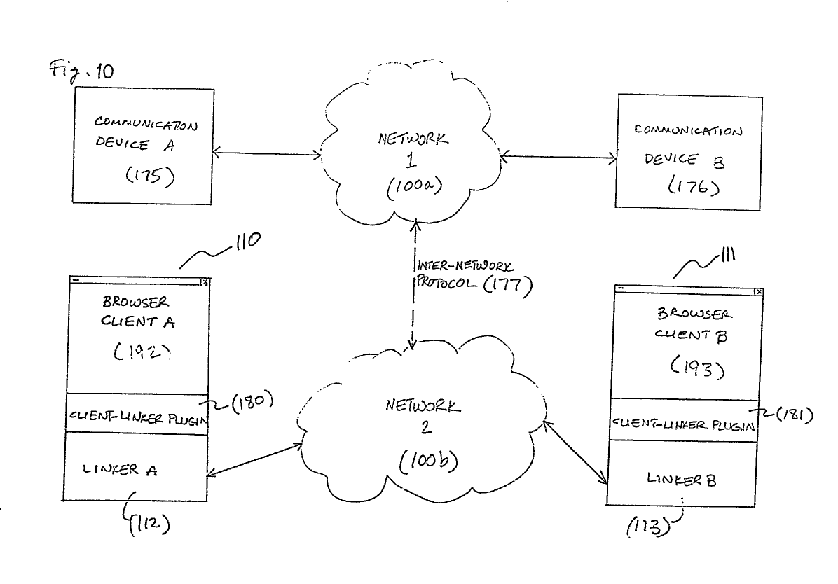

As discussed above, in one embodiment of the present invention, users in a multi-user group can communicate over another communication link in addition to the linked applications. This aspect of the present invention is illustrated conceptually in FIG. 10, wherein a first user has a first computer 10 having the capability of establishing a linked multi-user group via the linker 112, and the first user also has another communication device 175, such as a telephone. Similarly, the second user has a second computer 112 hat can also form a linked multi-user group using a linker 113, and further has a second communication device 176 (e.g., a telephone). As shown conceptually in FIG. 10, the two users can communicate over a first network 100a using the communication devices 175, 176, and can simultaneously communicate via shared client application over a second network 100b. In the illustrative embodiment of FIG. 10, the client application is shown as a web browser 192, 193. However, it should be appreciated that the embodiment of the present invention relating to having two simultaneous communication channels is not limited in this respect, and can be used with other client applications. In accordance with one embodiment of the present invention, the networks 100a, 100b can be coupled together (via an inter-network protocol 177 or otherwise), such that when the linked multi-user group is established over the network 100b, a communication link over the network 100a is automatically established. For example, when the communication channel through the network 100a is a telephone communication channel, the computers 110, 111 can be provided with a telephony application that can automatically dial up and establish a telephone link between the communication devices 175 and 176 when a linked multi-user group is formed.

Multiple Cursors

FIG. 8 conceptually illustrates another illustrative embodiment of the present invention that can be used in connection with the specific incremental updating embodiment described above in connection with FIG. 7, or in connection with any of the other embodiments of the present invention that can be used to enable linked multi-user sharing of any computer application that includes a cursor. Specifically, this embodiment of the present invention is directed to enabling each user in a linked multi-user group to simultaneously see the cursor of every other user in the group. In this way, each user can see where the other user has positioned his/her mouse cursor within the shared document.

It should be appreciated that the embodiment of the present invention that enables each of the users in a multi-user group to see the cursor positions of the other users in the group can be implemented in any of numerous ways, as the present invention is not limited to any particular implementation technique. For example, this can be done by transmitting the mouse cursor position information 253, 256 between the first and second computers 110, 111. The users may distinguish their own cursors from those of the other users in the group by having them appear in different colors, appear to be flashing, appear to have different shapes, or by any other means by which a distinction can be noticed by the user. In the example illustrated in FIG. 8, each user sees his/her own cursor as being black and those of another user as being white.

The ability to see all of the cursors in real-time can be advantageous for a number of different applications. For example, in one embodiment of the present invention, it is contemplated that in addition to the shared application for which a linked multi-user group has been formed, the users in a linked multi-user group can also communicate over a second communication link, such as a telephone line. Thus, with the users in voice communication over a telephone line, one user can move his/her cursor to a desired point in the document to highlight an issue to the other users in the group, and the other users will instantaneously see the positioning of the cursor and be able to follow along. Examples for applications where this may be beneficial include an educational environment, where an instructor may be interacting with a student, or in an on-line customer service situation, wherein service personnel may be corresponding with customers. For example, the documents 194, 195 may be related to a customer account, such as an investment (e.g., mutual fund) account.

In another embodiment of the present invention, different types of information can be passed between users in a linked multi-user group to facilitate cursor updates. For example, rather than simply sending information indicating the position of a cursor at a particular point in time, other information can be provided (e.g., including information relating to the speed of cursor movement, acceleration of the cursor, the heading direction of the cursor, etc.) that will enable the receiver to extrapolate future movement of the cursor. This may enable smoother motion of the on-screen pointer, and potentially minimize update delays when the position of a cursor changes.

As discussed above, in one embodiment of the present invention, two linked users can collaborate on the data contents of a Web page, but with the copies of the browsers in the linked groups including different information, such that one user need not have access to a complete Web page accessed by another linked user. One embodiment of the present invention relates to a technique for synchronizing the cursors with such a shared application, wherein the shared documents are not identical. In this respect, it should be appreciated that if two documents are not identical, relative X, Y coordinates for the cursors would not necessarily translate to the same pertinent portion of the shared documents. Thus, in accordance with one embodiment of the present invention, rather than exchanging raw X, Y coordinate information for a cursor, cursor positioning information can be provided relative to a landmark that is present in both copies of the shared document. For example, a command could be provided to move a cursor to a position ten pixels above an account balance text box, or some other landmark. While described above specifically in the context of a shared Web page, it should be appreciated that this aspect of the present invention can be used in connection with any shared data set.

In the description provided above, reference is made repeatedly to a cursor on a computer screen. As used herein, the term cursor is meant to refer to any pointer on a computer screen, and is not limited to any particular type of pointer.

On-line Assistance

According to one embodiment of the present invention, the aspects of the present invention described above can be used to assist a user in filling out an on-line document. For example, the user can use a web browser on his/her computer, such as the web browser 192 on the first computer 110, to access a web server 190 for a financial institution, and begin the process of filling out an on-line form. If the user needs assistance, the user can gain assistance from a service representative. This can be done in any of numerous ways, as the present invention is not limited to any particular implementation technique. As one example, the web page for the financial institution can include an icon that can be selected by a user to request assistance. Selection of the icon can result in an automatic creation of a linked multi-user group between the user and a service representative, wherein the service representation has a web server launched on another computer, such as the web browser 193 on the second computer 111. In this respect, the service representative can cause a copy of the on-line document to be transmitted to the service representative's browser. As the customer using the first computer 110 types information into the on-line form (e.g., social security number into Text box 251 and Name into text box 250), that information appears in essentially real-time on the screen of the customer service agent using the second computer, and appears in the corresponding text boxes, 250a and 251a in the manner described above. If there are fields in the on-line form that the user needs assistance in filling in (e.g., an account number, a code identifying a particular investment such as a particular mutual fund, etc.), the customer service agent can fill those fields in on his local copy 195 of the on-line form, which will result in the user's copy 194 of the on-line document being immediately updated with the correction information. As indicated above, the customer service agent and the customer can also communicate via another communication link, such as a telephone line to facilitate the transaction. Once the on-line form is completed, or the user no longer needs assistance, the linked multi-user group can be terminated, and the user can complete the transaction dealing directly with the web server 190 in the conventional fashion.

Hub and Spoke Topology

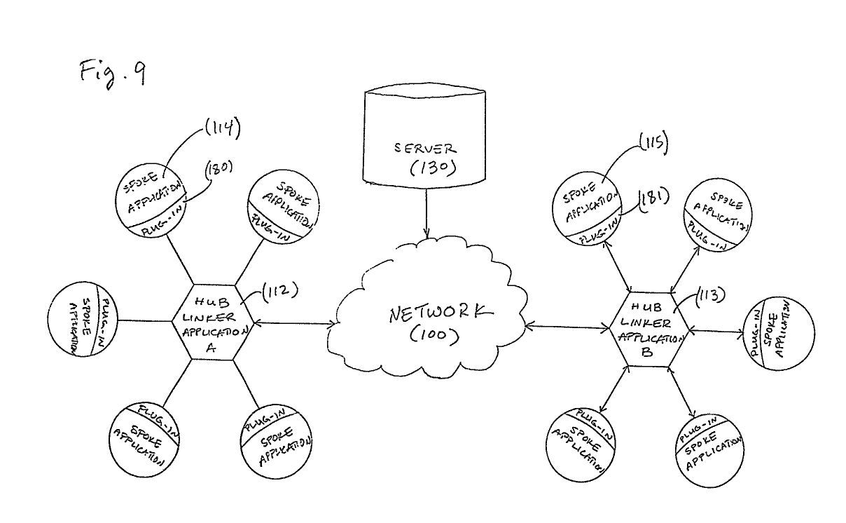

As discussed above, in one embodiment of the present invention, a same linker application can provide a single common interface for multiple client applications to be shared in a linked multi-user group. This embodiment of the present invention provides a number of advantages for users who are interested in performing multiple tasks within a linked multi-user group. In this respect, the common interface enables a linked multi-user group to be formed once, and enables the group to move between multiple shared applications without the need to terminate an old linked multi-user group and establish a new one each time the users of the group wish to move between applications, which is required using conventional systems. In addition, the common interface provides a common place wherein the make up of a linked multi-user group can be modified (i.e., by adding or removing users) and have those modifications apply to all of the multi-user applications that are shared by the multi-user group. This common interface embodiment of the present invention can be conceptualized as a hub and spoke topology as illustrated in FIG. 9.

FIG. 9 illustrates a pair of users A and B that can be linked together to form a linked multi-user group. A first user A has a computer with a first hub linker application 112 installed thereon, and a second user B has a computer with a hub linker application 113 installed thereon. The computers can communicate over a network 100 in the manner described above. The hub linker applications 112, 113 can perform the functions described above for the linker applications 112, 113 in FIG. 1. In addition, each hub linker application interfaces with a plurality of client applications identified in FIG. 9 as spoke applications 114, 115. Each of the spoke applications is capable of being shared in a linked multi-user group, either via the use of a plug-in interface 180, 181 or otherwise, with the plug-in interface also enabling the spoke application to communicate through the corresponding hub linker application 112, 113.

In the manner discussed above in connection with various other embodiments of the present invention, the hub linker applications 112, 113 can be used to establish a linked multi-user group between their associated users, and the hub & spoke topology enables the users of the multi-user group to seamlessly switch between any of the spoke applications 114, 115 while maintaining the linked multi-user group in continuous linked multi-user communication.

Security

In one embodiment of the present invention, various user preferences or security measures can be put in place to limit the users that have the ability to link together to form a linked multi-user group using the various embodiments of the invention discussed herein. For example, a password can be created so that before a user is authorized to send a link request to another user, a security server (e.g., the server 130 in FIG. 1) may require the first user to submit a password. The password may be matched with a password on the server, or alternatively may be matched with a password on the link request recipient's computer. This password scheme provides a screening method that limits the users that may link together in a linked multi-user group and may also reduce unwanted link requests sent from unauthorized users to users authorized to form a linked multi-user group. It should be appreciated that the present invention is not limited to employing these or any other security techniques.

Peer-to Peer

It should be appreciated that in some embodiments of the present invention, each of the communications between users during the formation and pendency of a linked multi-user group can be performed in a peer-to-peer manner. However, it should be appreciated that the present invention is not limited in this respect, and that other embodiments can alternatively be implemented in a client-server architecture.

Each of the above-described embodiments of the present invention can be implemented in any of numerous ways. For example, the above-discussed linkers and routines can be implemented in hardware, software or a combination thereof, either within the client computer systems, a dedicated server, or some other device in the computer system, or can be distributed throughout the system. When implemented in software, the routines can be executed on any suitable processor, such as the processors within the user computers, or any other processor in the computer system.

It should be appreciated that any single component or collection of multiple components of the computer system that perform the functions described above can be generically considered as one or more controllers that control the above-discussed functions. The one or more controllers can be implemented in numerous ways, such as with dedicated hardware, or using a processor that is programmed using microcode or software to perform the functions recited above. In this respect, it should be appreciated that one implementation of the present invention comprises at least one computer readable medium (e.g., a computer memory, a floppy disk, a compact disk, a tape, etc.) encoded with a program that, when executed on a processor, performs the above-discussed functions of the present invention. The computer readable medium can be transportable such that the program stored thereon can be loaded onto any computer system resource to implement the aspects of the present invention discussed above. In addition, it should be appreciated that the reference to a computer program that, when executed, performs the above-discussed functions is not limited to an application program running on application space on any computer. Rather, the term computer program is used here in a generic sense to reference any type of computer code (e.g., software or microcode) that can be employed to program a processor to implement the above-discussed aspects of the present invention.

Having discussed several embodiments of the invention in detail, various modifications and improvements will readily occur to those skilled in the art. Such modifications and improvements intended to be with the spirit and scope of the invention. Accordingly, the foregoing description is by way of example only, and is not intended as limiting. The invention is limited as only as defined by the following claims and the equivalents thereto.

What is claimed is:

1. A method for automatically launching a software application on a first computer, the first computer being coupled to a second computer, the method comprising acts of:
(A) receiving a link request at the first computer from the second computer, the link request identifying the software application, the link request further identifying a second user on the second computer and requesting that a first user on the first computer link with the second user to form a linked multi-user group that shares the software application; and
(B) responsive to the first user accepting the link request, automatically launching the software application on the first computer.

2. The method of claim 1, further including an act of accepting the link request, and wherein the acts of accepting the link request and automatically launching the software application are both performed in response to a same single action by the first user.

3. The method of claim 1, further including an act of accepting the link request to form the linked multi-user group with the first and second users sharing the software application.

4. The method of claim 1, further including an act of, prior to the act of launching the software application, automatically performing a check to ensure that the first and second computers have compatible versions of the software application installed thereon.

5. The method of claim 4, further including an act of, when it is determined that the first and second computers do not have compatible versions of the software application installed thereon, automatically installing a new version of the software application on at least one of the first and second computers.

6. A computer readable medium encoded with a computer program that, when executed on at least one computer, performs a method for automatically launching a software application on a first computer, the first computer being coupled to a second computer, the method comprising acts of:
(A) receiving a link request at the first computer from the second computer, the link request identifying the software application, the link request further identifying a second user on the second computer and requesting that a first user on the first computer link with the second user to form a linked multi-user group that shares the software application; and
(B) responsive to the first user accepting the link request, automatically launching the software application on the first computer.

7. The computer readable medium of claim 6, wherein the method further includes an act of accepting the link request, and wherein the acts of accepting the link request and automatically launching the software application are both performed in response to a same single action by the first user.

8. The computer readable medium of claim 6, wherein the method further includes an act of accepting the link request to form the linked multi-user group with the first and second users sharing the software application.

9. The computer readable medium of claim 6, wherein the method further includes an act of, prior to the act of launching the software application, automatically performing a check to ensure that the first and second computers have compatible versions of the software application installed thereon.

10. The computer readable medium of claim 9, wherein the method further includes an act of, when it is determined that the first and second computers do not have compatible versions of the software application installed thereon, automatically installing a new version of the software application on at least one of the first and second computers.

11. A first computer for use in a computer system that includes the first computer and a second computer coupled to the first computer, the first computer comprising:
at least one controller to receive a link request at the first computer from the second computer, the link request identifying a software application, the link request further identifying a second user on the second computer and requesting that a first user on the first computer link with the second user to form a linked multi-user group that shares the software application, wherein the at least one controller is responsive to the first user accepting the link request to automatically launch the software application on the first computer; and
at least one storage device to store the software application.

12. The first computer of claim 11, wherein the at least one controller is responsive to a same single action by the first user to accept the link request and automatically launch the software application.

13. The first computer of claim 13, wherein the at least one controller, prior to launching the software application, automatically performs a check to ensure that the first and second computers have compatible versions of the software application installed thereon.

14. The first computer of claim 13, wherein the at least one controller, when it determines that the first and second computers do not have compatible versions of the software application installed thereon, automatically installs a new version of the software application on the first computer.

15. The first computer of claim 11, wherein the at least one controller includes:
means for receiving the link request at the first computer from the second computer; and
means, responsive to the first user accepting the link request, for automatically launching the software application on the first computer.

16. A method for launching a software application on a first computer, the first computer being coupled to a second computer, the method comprising acts of:
(A) receiving a link request at the first computer from the second computer, wherein the link request identifies a second user on the second computer, provides an icon identifying the software application and requests that a first user on the first computer link with the second user to form a linked multi-user group that shares the software application; and
(B) selecting the icon to automatically launch the software application on the first computer.

17. The method of claim 16, wherein the act (B) includes an act of selecting the icon and automatically launching the software application in response to only a single action by the first user.

18. The method of claim 16, further including an act of accepting the link request to form the linked multi-user group with the first and second users sharing the software application.

19. The method of claim 16, further including an act of, prior to the act of launching the software application, automatically performing a check to ensure that the first and second computers have compatible versions of the software application installed thereon.

20. The method of claim 19, further including an act of, when it is determined that the first and second computers do not have compatible versions of the software application installed thereon, automatically installing a new version of the software application on at least one of the first and second computers.

21. The method of claim 16, further including an act of accepting the link request to form the linked multi-user group with the first and second users sharing the software application, and wherein the acts selecting the icon to automatically launch the software application and accepting the link request are both performed in response to same single action by the first user.

22. A computer readable medium encoded with a computer program that, when executed on at least one computer, performs a method for launching a software application on a first computer, the first computer being coupled to a second computer, the method comprising acts of:
(A) receiving a link request at the first computer from the second computer, wherein the link request identifies a second user on the second computer, provides an icon identifying the software application and requests that a first user on the first computer link with the second user to form a linked multi-user group that shares the software application; and
(B) selecting the icon to automatically launch the software application on the first computer.

23. The computer readable medium of claim 22, wherein the act (B) includes an act of selecting the icon and automatically launching the software application in response to only a single action by the first user.

24. The computer readable medium of claim 22, wherein the method further includes an act of accepting the link request to form the linked multi-user group with the first and second users sharing the software application.

25. The computer readable medium of claim 22, wherein the method further includes an act of, prior to the act of launching the software application, automatically performing a check to ensure that the first and second computers have compatible versions of the software application installed thereon.

26. The computer readable medium of claim 25, wherein the method further includes an act of, when it is determined that the first and second computers do not have compatible versions of the software application installed thereon, automatically installing a new version of the software application on at least one of the first and second computers.

27. The computer readable medium of claim 22, wherein the method further includes an act of accepting the link request to form the linked multi-user group with the first and second users sharing the software application, and wherein the acts selecting the icon to automatically launch the software application and accepting the link request are both performed in response to same single action by the first user.

28. A first computer for use in a computer system that includes the first computer and a second computer coupled to the first computer, the first computer comprising:
at least one controller to receive a link request at the first computer from the second computer, the link request providing an icon identifying a software application, the link request further identifying a second user on the second computer and requesting that a first user on the first computer link with the second user to form a linked multi-user group that shares the software application, wherein the at least one controller is responsive to the first user selecting the icon to automatically launch the software application on the first computer; and
at least one storage device to store the software application.

29. The first computer of claim 28, wherein the at least one controller is responsive to a same single action by the first user of selecting the icon to accept the link request and automatically launch the software application.

30. The first computer of claim 28, wherein the at least one controller, prior to launching the software application, automatically performs a check to ensure that the first and second computers have compatible versions of the software application installed thereon.

31. The first computer of claim 28, wherein the at least one controller, when it determines that the first and second computers do not have compatible versions of the software application installed thereon, automatically installs a new version of the software application on the first computer.

32. The first computer of claim 28, wherein the at least one controller includes:
means for receiving the link request at the first computer from the second computer; and
means, responsive to the first user selecting the icon, for automatically launching the software application on the first computer.

33. A method for facilitating launching of a software application on a first computer, the first computer being coupled to a second computer, the method comprising an act of:
(A) sending a link request from the second computer to the first computer, wherein the link request identifies a second user on the second computer and requests that a first user on the first computer link with the second user to form a linked multi-user group that shares the software application, and wherein the link request includes a launch icon that, when selected by the first user, automatically launches the software application on the first computer.

34. The method of claim 33, wherein the act (A) includes an act of sending a link request including a launch icon that, when selected by the first user, automatically causes the first and second users to be linked in the linked multi-user group with the software application being shared by the first and second users.

35. The method of claim 33, wherein the act (A) includes an act of sending a link request that includes a link icon that, when selected by the first user, automatically causes the first and second users to be linked in the linked multi-user group.

36. The method of claim 33, wherein the act (A) includes an act of sending a link request including a launch icon that, when selected by the first user, causes a check to be performed to ensure that the first and second computers have compatible versions of the software application installed thereon.

37. The method of claim 33, wherein the act (A) includes an act of sending a link request including a launch icon that, when selected by the first user, causes a check to be performed to ensure that the first and second computers have compatible versions of the software application installed thereon, and when it is determined that the first and second computers do not have compatible versions of the software application installed thereon, automatically causes a new version of the software application to be installed on at least one of the first and second computers.

38. A computer readable medium encoded with a computer program that, when executed on at least one computer, performs a method for facilitating launching of a software application on a first computer, the first computer being coupled to a second computer, the method comprising an act of:
(A) sending a link request from the second computer to the first computer, wherein the link request identifies a second user on the second computer and requests that a first user on the first computer link with the second user to form a linked multi-user group that shares the software application, and wherein the link request includes a launch icon that, when selected by the first user, automatically launches the software application on the first computer.

39. The computer readable medium of claim 38, wherein the act (A) includes an act of sending a link request including a launch icon that, when selected by the first user, automatically causes the first and second users to be linked in the linked multi-user group with the software application being shared by the first and second users.

40. The computer readable medium of claim 38, wherein the act (A) includes an act of sending a link request that includes a link icon that, when selected by the first user, automatically causes the first and second users to be linked in the linked multi-user group.

41. The computer readable medium of claim 38, wherein the act (A) includes an act of sending a link request including a launch icon that, when selected by the first user, causes a check to be performed to ensure that the first and second computers have compatible versions of the software application installed thereon.

42. The computer readable medium of claim 38, wherein the act (A) includes an act of sending a link request including a launch icon that, when selected by the first user, causes a check to be performed to ensure that the first and second computers have compatible versions of the software application installed thereon, and when it is determined that the first and second computers do not have compatible versions of the software application installed thereon, automatically causes a new version of the software application to be installed on at least one of the first and second computers.

43. A second computer for use in a computer system that includes a first computer and the second computer coupled to the first computer, the second computer comprising:
at least one controller to send a link request from the second computer to the first computer, wherein the link request identifies a second user on the second computer and requests that a first user on the first computer link with the second user to form a linked multi-user group that shares a software application, and wherein the link request includes a launch icon that, when selected by the first user, automatically launches the software application on the first computer; and
at least one storage device to store the software application.

44. The second computer of claim 43, wherein the at least one controller sends a link request including a launch icon that, when selected by the first user, automatically causes the first and second users to be linked in the linked multi-user group with the software application being shared by the first and second users.

45. The second computer of claim 43, wherein the at least one controller sends a link request that includes a link icon that, when selected by the first user, automatically causes the first and second users to be linked in the linked multi-user group.

46. The second computer of claim 43, wherein the at least one controller sends a link request including a launch icon that, when selected by the first user, causes a check to be performed to ensure that the first and second computers have compatible versions of the software application installed thereon.

47. The second computer of claim 43, wherein the at least one controller sends a link request including a launch icon that, when selected by the first user, causes a check to be performed to ensure that the first and second computers have compatible versions of the software application installed thereon, and when it is determined that the first and second computers do not have compatible versions of the software application installed thereon, automatically causes a new version of the software application to be installed on at least one of the first and second computers.

48. The first computer of claim 43, wherein the at least one controller includes:
means for sending the link request from the second computer to the first computer.

49. A method for initiating formation of a linked multi-user group between a first user on a first computer and a second user on a second computer coupled to the first computer, the method comprising an act of:
(A) transmitting from the first computer to the second computer a link request to form the linked multi-user group so that the first and second users can share at least one software application.

50. The method of claim 49, wherein the act (A) includes an act of performing a single action on the first computer that results in the transmitting of the link request.

51. The method of claim 50, wherein the act (A) includes an act of displaying on the first computer a list of users accessible for linking with the first user in a linked multi-user group, and wherein the single act includes an act of selecting from the list an icon corresponding to the second user.

52. The method of claim 49, further including, prior to the act (A), an act of launching a first software application on the first computer, and wherein the act (A) includes an act of transmitting a link request to the second computer that identifies the first software application and requests to form a linked multi-user group between the first and second users wherein the first software application launched on the first computer is shared with a compatible software application launched on the second computer.

53. A computer readable medium encoded with a computer program that, when executed on at least one computer, performs a method for initiating formation of a linked multi-user group between a first user on a first computer and a second user on a second computer coupled to the first computer, the method comprising an act of:
(A) transmitting from the first computer to the second computer a link request to form the linked multi-user group so that the first and second users can share at least one software application.

54. The computer readable medium of claim 53, wherein the act (A) includes an act of performing a single action on the first computer that results in the transmitting of the link request.

55. The computer readable medium of claim 54, wherein the act (A) includes an act of displaying on the first computer a list of users accessible for linking with the first user in a linked multi-user group, and wherein the single act includes an act of selecting from the list an icon corresponding to the second user.

56. The computer readable medium of claim 53, wherein the method further includes, prior to the act (A), an act of launching a first software application on the first computer, and wherein the act (A) includes an act of transmitting a link request to the second computer that identifies the first software application and requests to form a linked multi-user group between the first and second users wherein the first software application launched on the first computer is shared with a compatible software application launched on the second computer.

57. A first computer for use in a computer system that includes the first computer and a second computer coupled to the first computer, the first computer comprising:
at least one controller to transmit from the first computer to the second computer a link request to form a linked multi-user group between a first user on the first computer and a second user on the second computer so that the first and second users can share at least one software application; and
at least one storage device to store the at least one software application.

58. The first computer of claim 57, wherein the at least one controller transmits the link request in response to a single action performed by the first user.

59. The first computer of claim 58, wherein the at least one controller displays on the first computer a list of users accessible for linking with the first user in a linked multi-user group, and wherein the single action includes an act of selecting from the list an icon corresponding to the second user.

60. The first computer of claim 57, wherein the at least one controller, prior to transmitting the link request, launches a first software application on the first computer, and wherein the at least one controller transmits a link request to the second computer that identifies the first software application and requests to form a linked multi-user group between the first and second users wherein the first software application launched on the first computer is shared with a compatible software application launched on the second computer.

61. A method for completing formation of a linked multi-user group between a first user on a first computer and a second user on a second computer coupled to the first computer, the method comprising acts of:
(A) receiving, at the second computer, a link request transmitted from the first user requesting formation of a linked multi-user group between the first and second users so that the first and second users can share at least one software application; and
(B) accepting the link request at the second computer.

62. The method of claim 61, wherein the act (B) includes an act of performing a single action on the second computer that results in acceptance of the link request.

63. The method of claim 61, wherein the act (A) includes an act of receiving a link request that identifies at least one software application to be shared in the linked multi-user group.

64. The method of claim 61, wherein the act (B) includes an act of automatically forming the linked multi-user group in response to accepting the link request at the second computer.

65. A computer readable medium encoded with a computer program that, when executed on at least one computer, performs a method for completing formation of a linked multi-user group between a first user on a first computer and a second user on a second computer coupled to the first computer, the method comprising acts of:
(A) receiving, at the second computer, a link request transmitted from the first user requesting formation of a linked multi-user group between the first and second users so that the first and second users can share at least one software application; and
(B) accepting the link request at the second computer.

66. The computer readable medium of claim 65, wherein the act (B) includes an act of performing a single action on the second computer that results in acceptance of the link request.

67. The computer readable medium of claim 65, wherein the act (A) includes an act of receiving a link request that identifies at least one software application to be shared in the linked multi-user group.

68. The computer readable medium of claim 65, wherein the act (B) includes an act of automatically forming the linked multi-user group in response to accepting the link request at the second computer.

69. A second computer for use in a computer system that includes the second computer and a first computer coupled to the second computer, the second computer comprising:
at least one controller to receive and accept, at the second computer, a link request transmitted from a first user on the first computer requesting formation of a linked multi-user group between the first user and a second user on the second computer so that the first and second users can share at least one software application; and
at least one storage device to store the at least one software application.

70. The second computer of claim 69, wherein the at least one controller is responsive to a single action by the second user to accept the link request and complete formation of the linked multi-user group.

71. The second computer of claim 69, wherein the at least one controller receives a link request that identifies at least one software application to be shared in the linked multi-user group.

72. The second computer of claim 69, wherein the at least one controller automatically completes formation of the linked multi-user group in response to the second user accepting the link request at the second computer.

73. A method of adding an additional user to a linked multi-user group that includes at least first and second users that share at least one software application, the method comprising an act of:
(A) dynamically adding a third user to the linked multi-user group while maintaining the at least first and second users in continuous linked multi-user communication.

74. The method of claim 73, wherein the act (A) includes an act of initiating the dynamic adding of the third user by transmitting a request from one of the at least first and second users to the third user inviting the third user to join the linked multi-user group.

75. The method of claim 73, wherein the act (A) includes an act of initiating the dynamic adding of the third user by transmitting a request from any of the at least first and second users to the third user inviting the third user to join the linked multi-user group, so that all of the at least first and second users are authorized to invite the third user to join the linked multi-user group.

76. The method of claim 73, further including an act of distributing information identifying each of the users in the linked multi-user group among each of the users in the linked multi-user group.

77. A computer readable medium encoded with a computer program that, when executed on at least one computer, performs a method for adding an additional user to a linked multi-user group that includes at least first and second users that share at least one software application, the method comprising an act of:
(A) dynamically adding a third user to the linked multi-user group while maintaining the at least first and second users in continuous linked multi-user communication.

78. The computer readable medium of claim 77, wherein the act (A) includes an act of initiating the dynamic adding of the third user by transmitting a request from one of the at least first and second users to the third user inviting the third user to join the linked multi-user group.

79. The computer readable medium of claim 77, wherein the act (A) includes an act of initiating the dynamic adding of the third user by transmitting a request from any of the at least first and second users to the third user inviting the third user to join the linked multi-user group, so that all of the at least first and second users are authorized to invite the third user to join the linked multi-user group.

80. The computer readable medium of claim 77, further including an act of distributing information identifying each of the users in the linked multi-user group among each of the users in the linked multi-user group.

81. A first computer for use in a computer system that includes the first computer and a second computer coupled to the first computer, the first computer comprising:
at least one controller to dynamically add a third user to a linked multi-user group, previously formed between a first user on the first computer and a second user on the second computer so that the first and second users can share at least one software application, while maintaining the at least first and second users in continuous linked multi-user communication; and
at least one storage device to store the at least one software application.

82. The first computer of claim 81, wherein the at least one controller initiates the dynamic adding of the third user by transmitting a request from the first user to the third user inviting the third user to join the linked multi-user group.

83. The first computer of claim 81, wherein the at least one controller distributes information identifying each of the users in the linked multi-user group among each of the users in the linked multi-user group.

84. A method for enabling a first software application on a first computer to be shared in a linked multi-user group with at least one other compatible software application on a second computer coupled to the first computer, wherein the first software application has a plug-in port to interface with software add-ons and has no capability coded therein for enabling its use in a linked multi-user group, the method comprising an act of:
(A) providing a software add-on that is compatible with the plug-in port and that enables the first software application to be shared in a linked multi-user group with at least one other compatible software application on the second computer.

85. A computer readable medium encoded with a computer program that, when executed on at least one computer, performs a method for enabling a first software application on a first computer to be shared in a linked multi-user group with at least one other compatible software application on a second computer coupled to the first computer, wherein the first software application has a plug-in port to interface with software add-ons and has no capability coded therein for enabling its use in a linked multi-user group, the computer program including a software add-on that is compatible with the plug-in port, the method comprising an act of:
(A) interfacing the first software application with the at least one other compatible software application on the second computer to enable the first software application to be shared in a linked multi-user group with the at least one other compatible software application.

86. A method of managing membership of a linked multi-user group of users that share at least one software application, the linked multi-user group including at least first and second users, the method comprising an act of:
(A) authorizing at least the first and second users to each add additional users to the linked multi-user group.

87. The method of claim 86, wherein the act (A) includes an act of authorizing any one of the users in the linked multi-user group to add additional users to the linked multi-user group.

88. The method of claim 86, wherein the act (A) includes an act of initiating the adding of an additional user to the linked multi-user group by transmitting a request from one of the at least first and second users to the additional user inviting the additional user to join the linked multi-user group.

89. The method of claim 86, further including an act of:
(B) preventing any of the users of the linked multi-user group from removing another user from the linked multi-user group.

90. A method of managing membership of a linked multi-user group of users that share at least one software application, the linked multi-user group including a plurality of linked users, the method comprising an act of:
(A) preventing any of the plurality of linked users from removing another of the plurality of linked users from the multi-user group.

91. A method for facilitating creation of a linked multi-user group of users that share software applications on a first computer with compatible software applications on a second computer, the method comprising acts of:
(A) providing a multi-user linking interface on the first computer, the multi-user linking interface providing a common interface to at least two software applications on the first computer and being compatible with an interface on the second computer to enable the multi-user linking interface on the first computer to be used in establishing a linked multi-user group for the at least two software applications with compatible software applications on the second computer.

92. The method of claim 91, wherein the act (A) includes an act of providing a multi-user linking interface that maintains a same linked multi-user group for each of the at least two software applications for which linked multi-user groups are formed through the multi-user linking interface.

93. The method of claim 91, wherein the act (A) includes an act of providing a multi-user linking interface that allows a user to make changes to a single list of users for a linked multi-user group and have the changed list be applicable to each of the at least two software applications for which linked multi-user groups can be formed through the multi-user linking interface.

94. The method of claim 91, wherein the act (A) includes an act of providing a multi-user linking interface that displays to a user a list of the at least two software applications for which linked multi-user groups can be formed through the multi-user linking interface.

95. The method of claim 91, wherein the act (A) includes an act of providing a multi-user linking interface that provides a user with an ability to launch, directly from the multi-user linking interface, any of the at least two software applications for which linked multi-user groups can be formed through the multi-user linking interface.

96. The method of claim 95, wherein the act (A) includes an act of providing a multi-user linking interface that, when a user launches a software application directly from the multi-user linking interface, automatically forms a linked multi-user group, for the software application, that includes a group of users specified via the multi-user linking interface.

97. A computer readable medium encoded with a computer program that, when executed on at least one computer, performs a method for facilitating creation of a linked multi-user group of users that share software applications on a first computer with compatible software applications on a second computer, the method comprising an act of:
(A) providing a multi-user linking interface on the first computer, the multi-user linking interface providing a common interface to at least two software applications on the first computer and being compatible with an interface on the second computer to enable the multi-user linking interface on the first computer to be used in establishing a linked multi-user group for the at least two software applications with compatible software applications on the second computer.

98. The computer readable medium of claim 97, wherein the act (A) includes an act of providing a multi-user linking interface that maintains a same linked multi-user group for each of the at least two software applications for which linked multi-user groups are formed through the multi-user linking interface.

99. The computer readable medium of claim 97, wherein the act (A) includes an act of providing a multi-user linking interface that allows a user to make changes to a single list of users for a linked multi-user group and have the changed list be applicable to each of the at least two software applications for which linked multi-user groups can be are formed through the multi-user linking interface.

100. The computer readable medium of claim 97, wherein the act (A) includes an act of providing a multi-user linking interface that displays to a user a list of the at least two software applications for which linked multi-user groups can be formed through the multi-user linking interface.

101. The computer readable medium of claim 97, wherein the act (A) includes an act of providing a multi-user linking interface that provides a user with an ability to launch, directly from the multi-user linking interface, any of the at least two software applications for which linked multi-user groups can be formed through the multi-user linking interface.

102. The computer readable medium of claim 101, wherein the act (A) includes an act of providing a multi-user linking interface that, when a user launches a software application directly from the multi-user linking interface, automatically forms a linked multi-user group, for the software application, that includes a group of users specified via the multi-user linking interface.

103. A first computer for use in a computer system that includes the first computer and a second computer coupled to the first computer, the first computer comprising:
at least one controller to provide a multi-user linking interface on the first computer, the multi-user linking interface providing a common interface to at least two software applications on the first computer and being compatible with an interface on the second computer to enable the multi-user linking interface on the first computer to be used in establishing a linked multi-user group for the at least two software applications with compatible software applications on the second computer; and
at least one storage device to store the at least two software applications.

104. The first computer of claim 103, wherein the at least one controller provides a multi-user linking interface that maintains a same linked multi-user group for each of the at least two software applications for which linked multi-user groups are formed through the multi-user linking interface.

105. The first computer of claim 103, wherein the at least one controller provides a multi-user linking interface that allows a user to make changes to a single list of users for a linked multi-user group and have the changed list be applicable to each of the at least two software applications for which linked multi-user groups can be are formed through the multi-user linking interface.

106. The first computer of claim 103, wherein the at least one controller provides a multi-user linking interface that displays to a user a list of the at least two software applications for which linked multi-user groups can be formed through the multi-user linking interface.

107. The first computer of claim 103, wherein the at least one controller provides a multi-user linking interface that provides a user with an ability to launch, directly from the multi-user linking interface, any of the at least two software applications for which linked multi-user groups can be formed through the multi-user linking interface.

108. The first computer of claim 107, wherein the at least one controller provides a multi-user linking interface that, when a user launches a software application directly from the multi-user linking interface, automatically forms a linked multi-user group, for the software application, that includes a group of users specified via the multi-user linking interface.

109. A method for assisting a user in entering information into a computerized document via a software application executing on the user's computer, the method comprising acts of:
(A) creating a linked multi-user group between the user and a service representative so that the software application executing on the user's computer can be shared with a compatible software application executing on a computer used by the service representative;
(B) transmitting a copy of the computerized document from the user's computer to the computer used by the service representative so that the service representative and the user can enter information in the computerized document simultaneously.

110. The method of claim 109, wherein the computerized document is a web page and the software application is a web browser, and wherein the act (B) includes an act of transmitting a copy of the web page from the user's computer to the computer used by the service representative using peer-to-peer communication.

111. The method of claim 109, wherein the act (A) is performed in response to the user selecting an icon to request help from service personnel.

112. The method of claim 109, further including an act of establishing a second communication channel between the service representative and the user so that the user and the service representative can communicate via the linked multi-user group and the second communication channel simultaneously.

113. A computer readable medium encoded with a computer program that, when executed on at least one computer, performs a method for assisting a user in entering information into a computerized document via a software application executing on the user's computer, the method comprising acts of:
(A) creating a linked multi-user group between the user and a service representative so that the software application executing on the user's computer can be shared with a compatible software application executing on a computer used by the service representative;
(B) transmitting a copy of the computerized document from the user's computer to the computer used by the service representative so that the service representative and the user can enter information in the computerized document simultaneously.

114. The computer readable medium of claim 113, wherein the computerized document is a web page and the software application is a web browser, and wherein the act (B) includes an act of transmitting a copy of the web page from the user's computer to the computer used by the service representative.

115. The computer readable medium of claim 113, wherein the act (A) is performed in response to the user selecting an icon to request help from service personnel.

116. The computer readable medium of claim 113, wherein the method further includes an act of establishing a second communication channel between the service representative and the user so that the user and the service representative can communicate via the linked multi-user group and the second communication channel simultaneously.

117. A first computer for use by a user in a computer system that further includes a second computer used by a service representative, the first computer comprising:
at least one controller to create a linked multi-user group between the user and the service representative so that a software application executing on the user's computer can be shared with a compatible software application executing on the second computer used by the service representative, the at least one controller to further transmit a copy of a computerized document from the first computer to the second computer so that the service representative and the user can enter information in the computerized document simultaneously; and
at least one storage device to store the software application.

118. The first computer of claim 117, wherein the computerized document is a web page and the software application is a web browser, and wherein the at least one controller transmits a copy of the web page from the first computer to the second computer.

119. The first computer of claim 117, wherein the at least one controller creates the linked multi-user group in response to the user selecting an icon to request help from service personnel.

120. A method for enabling shared access to a web page between a first user on a first computer and a second user on a second computer, the method comprising acts of:
(A) creating a linked multi-user group between the first and second users to enable a first web browser executing on the first computer to be shared with a compatible second web browser executing on the second computer; and
(B) transmitting a copy of at least a portion of the web page from the first web browser to the second web browser.

121. The method of claim 120, further including acts of:
(C) maintaining coherency between the copies of the web pages on the first and second web browsers by transferring information between the first and second web browsers via the linked multi-user group.

122. The method of claim 120, wherein the act (B) includes an act of transmitting less than the entire web page from the first web browser to the second web browser.

123. The method of claim 121, wherein the act (C) includes an act of, when the first user updates a copy of the web page on the first web browser, transferring only the updated portion of the web page to the second web browser.

124. A computer readable medium encoded with a computer program that, when executed on at least one computer, performs a method for enabling shared access to a web page between a first user on a first computer and a second user on a second computer, the method comprising acts of:
(A) creating a linked multi-user group between the first and second users to enable a first web browser executing on the first computer to be shared with a compatible second web browser executing on the second computer; and
(B) transmitting a copy of at least a portion of the web page from the first web browser to the second web browser.

125. The computer readable medium of claim 124, wherein the method further includes acts of:
(C) maintaining coherency between the copies of the web pages on the first and second web browsers by transferring information between the first and second web browsers via the linked multi-user group.

126. The computer readable medium of claim 124, wherein the act (B) includes an act of transmitting less than the entire web page from the first web browser to the second web browser.

127. The computer readable medium of claim 125, wherein the act (C) includes an act of, when the first user updates a copy of the web page on the first web browser, transferring only the updated portion of the web page to the second web browser.

128. A first computer for use by a user in a computer system that the first computer and a second computer coupled to the first computer, the first computer comprising:
at least one controller to create a linked multi-user group, between a first user on the first computer and a second user on the second computer, that enables a first web browser executing on the first computer to be shared with a compatible second web browser executing on the second computer, the at least one controller to further transmit a copy of at least a portion of a web page from the first web browser to the second web browser to enable the first and second users to share the at least a portion of the web page; and
at least one storage device to store the first web browser.

129. The first computer of claim 128, wherein the at least one controller maintains coherency between the copies of the web pages on the first and second web browsers by transferring information between the first and second web browsers via the linked multi-user group.

130. The first computer of claim 128, wherein the at least one controller, responsive to the first user updating a copy of the web page on the first web browser, transfers only the updated portion of the web page to the second web browser.

131. The first computer of claim 128, wherein the at least one controller includes:
means for creating a linked multi-user group, between a first user on the first computer and a second user on the second computer, that enables a first web browser executing on the first computer to be shared with a compatible second web browser executing on the second compute; and
means for transmitting a copy of at least a portion of a web page from the first web browser to the second web browser to enable the first and second users to share the at least a portion of the web page.

132. The method of claim 1, wherein the act (A) includes an act of receiving the link request in a peer-to-peer communication.

133. The method of claim 1, further including an act of forming the linked multi-user group and sharing the software application using peer-to-peer communication.

134. The method of claim 49, wherein the act (A) includes an act of transmitting the link request in a peer-to-peer communication.

135. The method of claim 49, further including an act of forming the linked multi-user group and sharing the at least one software application using peer-to-peer communication.

136. The method of claim 73, wherein the act (A) includes an act of dynamically adding the third user using peer-to-peer communication.

137. The method of claim 73, further including an act of maintaining the at least first and second users in continuous peer-to-peer linked multi-user communication.

138. The method of claim 84, wherein the act (A) includes an act of providing a software add-on that communicates with the at least one other compatible software application using peer-to-peer communication.

139. The method of claim 120, wherein the act (B) includes an act of transmitting the copy of the at least a portion of the web page using peer-to-peer communication.

140. A method of updating a first pointer on a first computer executing a first software application that is shared with a second software application executing on a second computer, the first pointer representing a position of a second pointer on the second computer, the method comprising an act of:
(A) in response to a user moving the second cursor on the second computer, transmitting information from the second computer to the first computer that enables the first computer to predict future positioning of the second cursor.

141. A method of updating a first pointer on a first computer executing a first software application that is shared with a second software application executing on a second computer, the first pointer representing a position of a second pointer on the second computer, the method comprising an act of:
(A) receiving, at the first computer, information relating to movement of the second cursor; and
(B) predicting future movement of the first cursor based on the information.

142. A method of updating a first pointer on a first computer executing a first software application that is shared with a second software application executing on a second computer, the first pointer representing a position of a second pointer on the second computer, the first software application having a first document associated therewith, the second software application having a second document associated therewith, wherein one of the first and second documents includes only a subset of the information in the other, the method comprising an act of:
(A) in response to a user moving the second cursor on the second computer, transmitting information from the second computer to the first computer that defines a position of the second cursor relative to a landmark in the second document that is also in the first document.

143. A method of updating a first pointer on a first computer executing a first software application that is shared with a second software application executing on a second computer, the first pointer representing a position of a second pointer on the second computer, the first software application having a first document associated therewith, the second software application having a second document associated therewith, wherein one of the first and second documents includes only a subset of the information in the other, the method comprising an act of:
(A) receiving, at the first computer, information from the second computer that defines a position of the second cursor relative to a landmark in the second document that is also in the first document; and
(B) updating a position of the first cursor based on the information.

144. A method for use in a computer system including first and second computers that are coupled together and share a software application, the method comprising an act of:
(A) displaying, on a display of the first computer, first and second pointers, wherein a position of the first pointer is controlled by a user of the first computer and wherein a position of the second pointer is controlled by a user of the second computer.

145. The method of claim 144, further including an act of receiving, at the first computer, in a peer-to-peer communication, information relating to the position of the second pointer.
